(19) United States
(12) Patent Application Publication
(10) Pub. No.: US 2026/0023605 A1
(43) Pub. Date: Jan. 22, 2026

(54) HINT-BASED MEMORY MANAGEMENT ELECTRONIC DEVICES AND METHODS FOR GENERATIVE ARTIFICIAL INTELLIGENCE MODELS

(71) Applicant: Samsung Electronics Co., Ltd., Suwon-si (KR)

(72) Inventors: Anuradha KANUKOTLA, Bangalore (IN); Naresh Kumar N, Bangalore (IN); Sivagurunathan T, Bangalore (IN); Irfan ABDUL, Bangalore (IN); Syama SUDHEESH, Bangalore (IN); Sripurna MUTALIK, Bangalore (IN); Sharan Kumar ALLUR, Bangalore (IN); Dwaraka Bhamidipati SREEVATSA, Bangalore (IN); Gyeonghwan HONG, Suwon-si (KR)

(21) Appl. No.: 19/278,201

(22) Filed: Jul. 23, 2025

Related U.S. Application Data
(63) Continuation of application No. PCT/KR2025/010552, filed on Jul. 17, 2025.

(30) Foreign Application Priority Data
Jul. 17, 2024 (IN) 202441054588
Jun. 26, 2025 (IN) 2024 41054588

(51) Int. Cl. G06F 9/50

(52) U.S. Cl. CPC G06F 9/5016

(57) ABSTRACT

A method is provided. The method includes detecting one or more hint signals indicating a task to be performed using the one or more generative artificial intelligence (GenAI) models, validating the one or more detected hint signals by at least one condition related to a task execution status or authorization of a GenAI application associated with the one or more GenAI models, determining a memory demand and a priority level for the task based on the validated one or more detected hint signals, selecting one or more memory reclaimers based on the determined memory demand and the priority level, initiating a memory reclamation process using the selected one or more memory reclaimers, and allocating reclaimed memory associated with the memory reclamation process to the task based on receiving a request to execute the task.

### CROSS-REFERENCE TO RELATED APPLICATION(S)

This application is a continuation application, claiming priority under 35 U.S.C. § 365 (c), of an International application No. PCT/KR2025/010552, filed on Jul. 17, 2025, which is based on and claims the benefit of an Indian Provisional patent application number 202441054588, filed on Jul. 17, 2024, in the Indian Intellectual Property Office, and of an Indian Complete patent application No. 202441054588, filed on Jun. 26, 2025, in the Indian Intellectual Property Office, the disclosure of each of which is incorporated by reference herein in its entirety.

### FIELD OF THE INVENTION

The disclosure relates to memory management in computing devices. More particularly, the disclosure relates to a hint-based memory management electronic device and method for allocating reclaimed memory during execution of Generative Artificial Intelligence (GENAI) models.

### BACKGROUND

With the increasing adoption of on-device Generative Artificial Intelligence (GenAI) functionalities in computing devices, efficient memory management has become a significant concern. The GenAI models, such as large language models (LLMs) and image generation models, typically require 3-5 GB of contiguous memory space for loading and execution. The GenAI models often utilize Direct Memory Access (DMA) buffers to transfer data to Random Access Memory (RAM) without a Central Processing Unit (CPU) involvement, which mandates large contiguous memory regions.

Under ideal memory conditions, the GenAI models can be loaded into memory with minimal CPU intervention. In real-world scenarios, where multiple applications are concurrently running and system memory is heavily utilized, attempts to load a GenAI model often trigger low-memory conditions. In such cases, a related system invokes related memory reclaimers, such as Low Memory Killer (LMKD) Daemon, Kernel Swap Daemon (KSWAPD), or other system memory reclaimers. The related memory reclaimers attempt to free memory by terminating or swapping out low-priority background applications. A reactive approach of the related memory reclaimers introduces a significant delay in the GenAI model loading and degrades the user experience, particularly when returning to previously running tasks after the GenAI use case has completed.

In an example test scenario, when 35 applications are maintained in the background and the GenAI model is launched, 13 background applications are terminated as a result of aggressive memory reclamation triggered by a low-memory state. The termination of the background applications is primarily due to inability to find sufficient contiguous memory blocks required for DMA-based model loading under high memory pressure.

Additionally, with growing privacy and latency concerns, there is a strong user preference for executing AI workloads locally on-device instead of offloading to cloud-based services. As use cases become increasingly prevalent, the inadequacy of existing reactive memory management techniques becomes more pronounced, highlighting the need for a proactive, context-aware, and GenAI-optimized memory management solution.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a hint-based memory management system and method for allocating reclaimed memory during execution of Generative Artificial Intelligence (GENAI) models.

Additional aspects will be set forth in part in the description which follows and, in part, will be apparent from the description, or may be learned by practice of the presented embodiments.

In accordance with an aspect of the disclosure, a method is provided. The method includes detecting one or more hint signals indicating a task to be performed using the one or more generative artificial intelligence (GenAI) models. In an embodiment, the method includes validating the one or more detected hint signals by at least one condition related to a task execution status or authorization of a GenAI application associated with the one or more GenAI models. In an embodiment, the method includes determining a memory demand and a priority level for the task based on the validated one or more detected hint signals. In an embodiment, the method includes selecting one or more memory reclaimers based on the determined memory demand and the priority level. In an embodiment, the method includes initiating a memory reclamation process using the selected one or more memory reclaimers. In an embodiment, the method includes allocating reclaimed memory associated with the memory reclamation process to the task based on receiving a request to execute the task.

In accordance with an aspect of the disclosure, an electronic device is provided. The electronic device includes memory, comprising one or more storage media, storing instructions. The electronic device includes at least one processor communicatively coupled with the memory. In an embodiment, the instructions, when executed by the at least one processor individually or collectively, cause the electronic device to detect one or more hint signals indicating a task to be performed using the one or more GenAI models. In an embodiment, the instructions, when executed by the at least one processor individually or collectively, cause the electronic device validate the one or more detected hint signals by at least one condition related to a task execution status or authorization of a GenAI application associated with the one or more GenAI models. In an embodiment, the instructions, when executed by the at least one processor individually or collectively, cause the electronic device determine a memory demand and a priority level for the task based on the validated one or more detected hint signals. In an embodiment, the instructions, when executed by the at least one processor individually or collectively, cause the electronic device select one or more memory reclaimers based on the determined memory demand and the priority level. In an embodiment, the instructions, when executed by the at least one processor individually or collectively, cause the electronic device initiate a memory reclamation process using the selected one or more memory reclaimers. In an embodiment, the instructions, when executed by the at least one processor individually or collectively, cause the electronic device to allocate reclaimed memory associated with the memory reclamation process to the task based on receiving a request to execute the task.

In accordance with an aspect of the disclosure, a computer-readable storage media storing one or more computer programs including computer-executable instructions that, when executed by one or more processors, cause the electronic device to perform operations are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a flow diagram depicting a related method involved in loading Generative Artificial Intelligence (GenAI) model into memory using a Direct Memory Access (DMA) controller, according to the related art;

FIG. 1B illustrates a scenario depicting an execution of a GenAI application, according to the related art;

FIG. 2 illustrates a block diagram depicting an environment for implementation of a system for allocating a reclaimed memory associated with a memory reclamation process to a task for one or more Generative Artificial Intelligence (GenAI) Models, according to an embodiment of the disclosure;

FIG. 3 illustrates a block diagram of the system, according to an embodiment of the disclosure;

FIG. 4A illustrates a flowchart depicting a method for allocating reclaimed memory associated with the memory reclamation process to the task, according to various embodiments of the disclosure;

FIG. 4B illustrates a flowchart depicting a method for allocating reclaimed memory associated with the memory reclamation process to the task, according to various embodiments of the disclosure;

FIG. 5 illustrates a block diagram depicting an embodiment of a hint-based memory management engine, according to an embodiment of the disclosure;

FIG. 6 illustrates a block diagram depicting an embodiment of the hint-based memory management engine, according to an embodiment of the disclosure;

FIG. 7 illustrates an architecture depicting the hint-based memory management engine, according to an embodiment of the disclosure;

FIG. 8 illustrates a flow diagram depicting a method for performing post-GenAI operations, according to an embodiment of the disclosure;

FIG. 9 illustrates a flow diagram depicting a method for validating the one or more detected hints associated with the GenAI application, according to an embodiment of the disclosure;

FIG. 10 illustrates a flow diagram depicting a method for initiating the memory reclamation process, according to an embodiment of the disclosure;

FIG. 11 illustrates a flow diagram depicting a method for unloading the one or more GenAI models from the memory, according to an embodiment of the disclosure;

FIG. 12 illustrates a flow diagram depicting a method for prefetching the memory pages and restore the memory pages by a PostGenAI stability handling module, according to an embodiment of the disclosure;

FIG. 13A illustrates an example use case for displaying results to the user on a user device, according to an embodiment of the disclosure;

FIG. 13B illustrates an example use case for displaying results to the user on a user device, according to an embodiment of the disclosure;

FIG. 14 illustrates an example use case for triggering a writing assistant within an email composition on the user device, according to an embodiment of the disclosure;

FIG. 15A illustrates an example use case depicting selecting an original image on a user device using one or more GenAI models, according to an embodiment of the disclosure;

FIG. 15B illustrates an example use case depicting marking a pencil image associated with the original image on the user device using the one or more GenAI, according to an embodiment of the disclosure;

FIG. 16A illustrates an example use case depicting adjusting background of the original image, according to an embodiment of the disclosure;

FIG. 16B illustrates an example use case depicting out-painting the background of the original image, where the background of the original image is extended on the user device using the one or more GenAI models, according to an embodiment of the disclosure;

FIG. 17A illustrates an example use case for providing notes intelligence on the user device using the one or more GenAI models, according to an embodiment of the disclosure;

FIG. 17B illustrates an example use case for providing notes intelligence on the user device using the one or more GenAI models, according to an embodiment of the disclosure;

FIG. 18 illustrates an example use case for providing call translation and summarization on the user device using the one or more GenAI models, according to an embodiment of the disclosure;

FIG. 19 illustrates an example use case for improving performance of memory-hungry applications on the user device using the one or more GenAI models, according to an embodiment of the disclosure;

FIG. 20 illustrates a scenario depicting the execution of a GenAI application, according to an embodiment of the disclosure; and

FIG. 21 illustrates a diagram depicting a Low Memory Killings (LMK) comparison chart, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the disclosure will be described below in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

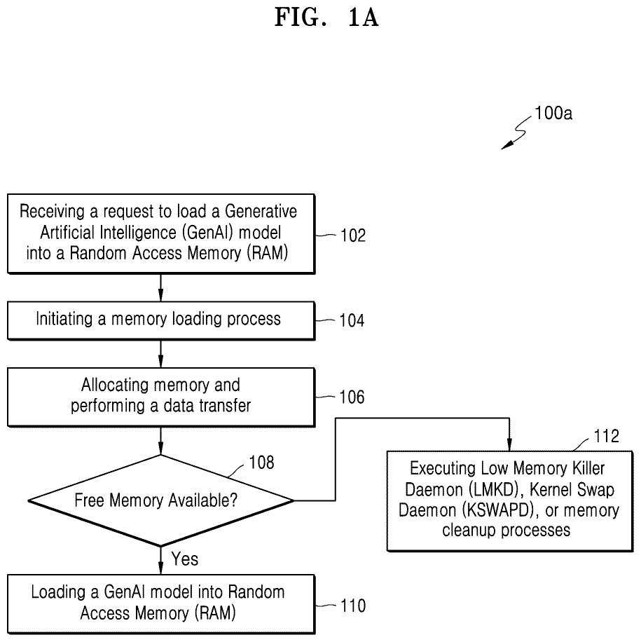

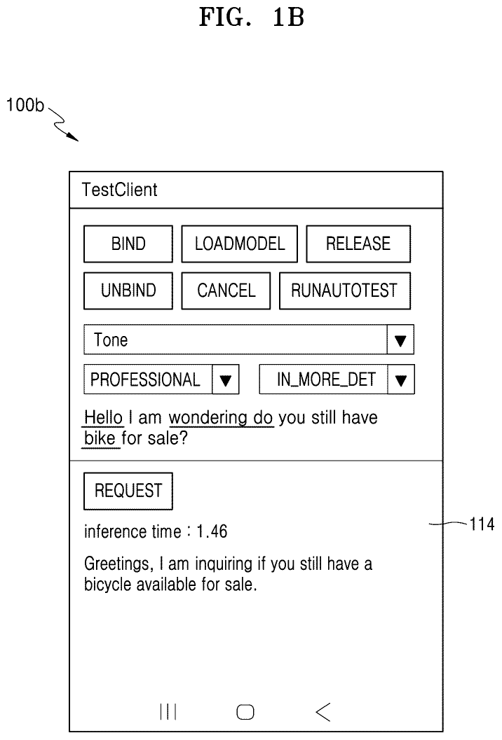

FIG. 1A illustrates a flow diagram depicting a related method 100a involved in loading Generative Artificial Intelligence (GenAI) model into memory using a Direct Memory Access (DMA) controller, according to the related art.

The related method 100a highlights inefficiencies encountered in memory-constrained environments and the reactive nature of related memory reclaimers.

The method 100a begins at operation 102, when a request is made to load the GenAI model into Random Access Memory (RAM) for execution. The GenAI model is typically large (e.g., 3-5 GB) and requires contiguous memory due to the use of DMA buffers.

At operation 104, the method 100a includes initiating by a Central Processing Unit (CPU) a memory loading process. Under ideal conditions, the DMA controller would handle the transfer with minimal CPU involvement.

At operation 106, the method 100a includes allocating memory and performing data transfer by the DMA controller. The DMA controller is efficient because the DMA controller can move data directly from storage to the RAM without significant CPU overhead.

At operation 108, the method 100a includes determining whether sufficient contiguous free memory is available? If the sufficient contiguous free memory is available, at operation 110, the method 100a includes loading the GenAI model into the RAM directly. If the sufficient contiguous free memory is not available, the method 100a continues at operation 104.

Upon failing to find the adequate memory, at operation 112, the method includes, triggering related memory reclaimers such as Low Memory Killer Daemon (LMKD), Kernel Swap Daemon (KSWAPD), or similar memory cleanup processes. The related memory reclaimers attempt to free memory by terminating or swapping out background applications and low-priority tasks. The termination of the background applications causes additional delays and often disrupts a user experience.

FIG. 1B illustrates a scenario depicting 100b an execution of a GenAI application 114, according to the related art.

In related computing environments, particularly a resource-constrained system such as a smartphone, memory utilization is tightly coupled with application performance. Prior to the launch of large-scale GenAI applications, the resource-constrained system exhibits seemingly sufficient memory availability. Contiguous memory is needed for loading the GenAI application 114.

The disclosure aims to preemptively manage memory before reaching a critical low memory state. The disclosure introduces predictive or adaptive memory management, selectively reclaiming memory based on task priority, application state, and memory availability, before Generative Artificial Intelligence (GenAI) model loading.

Therefore, in view of the above-mentioned problems, it is advantageous to provide an improved system and method that can overcome the above-mentioned problems and limitations associated with the threat actors and phishing scams.

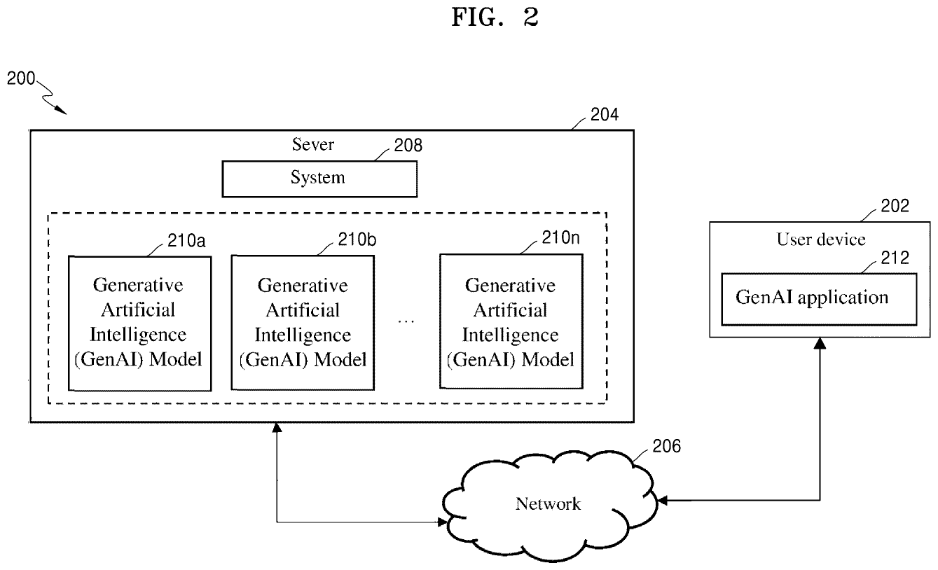

FIG. 2 illustrates a block diagram depicting an environment 200 for implementation of a system 208 for allocating a reclaimed memory associated with a memory reclamation process to a task for one or more Generative Artificial Intelligence (GenAI) Models 210a, 210b . . . 210n, according to an embodiment of the disclosure.

In an embodiment, the environment 200 may include a user device 202 and a server 204. The user device 202 may include, but are not limited to, a smartphone, a tablet, a laptop, a smartwatch, an Augmented Reality (AR) headset, a Virtual Reality (VR) headset, or an Extended Reality (XR) headset, an embedded system with display and input capabilities, and the like.

In an embodiment, the server 204 may be a unitary server or a distributed server spanning multiple computers or multiple data centers. The server 204 may be of various types, such as, for example, and without limitation, a web server, an application server, a database server, a proxy server, another server suitable for performing functions or processes described herein, or any combination thereof. In an embodiment, the server 204 may include hardware, software, or embedded logic components or a combination of two or more such components for carrying out the appropriate functionalities implemented or supported by the server 204.

The user device 202 and the server 204 may be connected through a network 206. In an implementation, the network 206 may include a wireless network. For example, the network 206 corresponds to cellular networks or mobile networks, such as third-generation (3G), fourth-generation (4G), fifth-generation (5G), pre-5G, and sixth-generation (6G) networks, or any other next-generation wireless communication network.

Further, the server 204 may include the system 208. In an embodiment, the system 208 may be implemented within the server 204. In an embodiment, the system 208 may be externally connected to the server 204. In an embodiment, some parts of the system 208 may be externally connected to the server 204, and other parts of the system 208 may be implemented within the server 204.

The system 208 may be configured to detect one or more hints indicating the task to be performed using the one or more GenAI models 210a, 210b . . . 210n. The task may include, but not limited to, a foreground activity launch, a system-level Application Programming Interface (API) call, a broadcast event, a framework API call, or a user interaction indicating execution of the task associated with a Generative Artificial Intelligence (GenAI) application 212.

The one or more GenAI models 210a, 210b . . . 210n may be machine learning models typically deep neural networks, that are trained to generate content based on learned patterns in input data. The one or more GenAI models 210a, 210b . . . 210n may include, but are not limited to, Large Language Models (LLMs) for generating text, diffusion models for image or video generation, transformer-based multi-modal models for understanding and generating across different content types (text, image, audio). The one or more GenAI models 210a, 210 . . . 210n may include, but are not limited to, Gauss LLM model for auto reply, Gauss LVM model for wallpaper generation in-out painting, and the like.

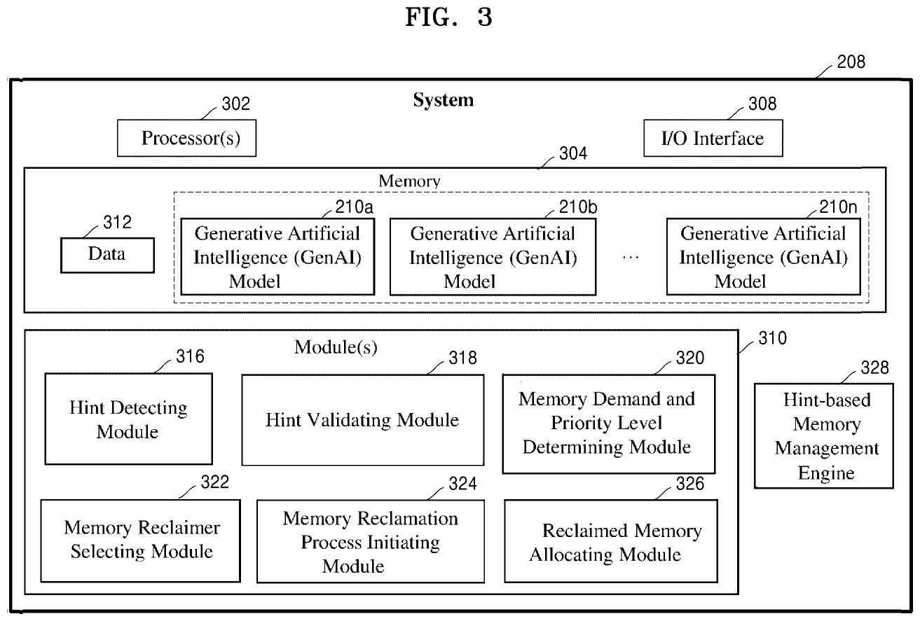

The GenAI application 212 may refer to a software application, an application that loads and executes the one or more GenAI models 210a, 210b . . . 210n (shown in FIG. 3), or a service that integrates artificial intelligence capabilities. The GenAI application 212 may require large memory allocations, compute-intensive processing, and low-latency inference. Further, the GenAI application 212 may execute the one or more GenAI models 210a, 210b . . . 210n through the server 204. The one or more GenAI models 210a, 210b . . . 210n typically demand substantial and contiguous memory blocks, freeing memory from lower-priority background processes enables smoother and faster access to the one or more GenAI models 210a, 210b . . . 210n.

The system 208 may be configured to allocate the reclaimed memory associated with the memory reclamation process to the task. The reclaimed memory may indicate memory resources that have been previously allocated to one or more low-priority applications. The memory reclamation process may include performing one or more adaptive reclamation strategies configured to selectively release memory based on an application state and a memory demand. In an embodiment, the one or more adaptive reclamation strategies may include, but are not limited to, dropping recycle bin cache, performing MGLRU aging to reclaim pages faster, writing anonymous pages to Zipped Random Access Memory (ZRAM), and the like.

In an embodiment, the memory reclamation process may include a prioritized approach to avoid killing non-GenAI applications while efficiently freeing up the memory. The prioritized approach may include excluding important processes, including background processes, sorting the processes based on scores, and performing reclamation (largest to smallest).

In an embodiment, excluding important processes may include skipping the non-GenAI applications predicted to be used next (e.g., top 5 or top 10 based on user behavior). The system 208 may be configured to protect critical system processes like a system User Interface (UI) and the GenAI application 212.

The system 208 may include background processes, such as target processes running in the background, which are less likely to impact on a user experience when selected for the memory reclamation process.

In an embodiment, the system 208 may be configured to use machine learning regression to generate a score for each process based on frequency of usage (less frequent=higher priority), last idle time (longer idle=higher priority), and reclaimable memory size (larger=higher priority).

In an embodiment, the system 208 may be configured to reclaim memory incrementally, starting with the process with a highest score (least critical or largest memory footprint).

In an embodiment, the system 208 may be configured to prioritize the memory reclamation process by excluding critical applications (e.g., System UI, launcher) and next-used applications, targeting background processes with larger memory footprints and lower usage frequency, ensuring efficient memory recovery without disrupting the user experience.

For a launch event of the GenAI application 212, aging of memory pages may be executed proactively to understand page idleness for reclamation. For example, recycle bin, which is of 500 MB-1 GB, may be cleared (The Recycle bins carve out of memory for managing file pages; after freeing up file pages, still maintained in the recycle bin for improving access time). Reclamation of older generations of memory pages based on aging performed in precondition, the range of size is fixed from 300 MB to ˜500 MB.

In an embodiment, the system 208 may be configured to identify anonymous-memory pages from each process and move to a Zipped Random Access Memory (ZRAM) quickly using a multithread pool. The multithread pool may include the one or more memory reclaimers 1, 2, 3 . . . . N. The system 208 may be configured to save process maps table. The system 208 may be configured to use a separate writeback thread to move the anonymous-memory pages from the ZRAM to NANDSWAP flash memory by using the queue, and the memory page may be dropped if the memory page is a file page type.

The application state may refer to an operational condition of application including, but not limited to, a GenAI application 212. The operational condition may include, but not limited to, an idle state, a foreground or active state, a background state, a loading state, an execution state, a terminated state, and the like. The memory demand may refer to the amount of memory required by the GenAI application 212 to execute operations, such as loading the one or more GenAI Models 210a, 210b . . . 210n and processing inputs. The system 208 is described in greater detail in conjunction with FIG. 3 in the forthcoming paragraphs.

FIG. 3 illustrates a block diagram of the system 208, according to an embodiment of the disclosure.

The system 208 may include, but not limited to, one or more processors 302, memory 304, an input/output (I/O) interface 308, and one or more modules 310. The one or more modules 310 and the memory 304 may be coupled to the one or more processors 302.

As an example, the one or more processors 302 may be a single processing unit or several units, all of which could include multiple computing units. The one or more processors 302 may include processing circuitry. The one or more processors 302 may be implemented as one or more microprocessors, microcomputers, microcontrollers, digital signal processors, central processing units, state machines, logic circuitries, and/or any devices that manipulate signals based on operational instructions. Among other capabilities, the one or more processors 302 are adapted to fetch and execute computer-readable instructions and data stored in the memory 304. The one or more processors 302 may be configured to fetch and execute computer-readable instructions and data stored in the memory 304.

The one or more processors 302 may include one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors may control the processing of the input data in accordance with a predefined operating rule or an artificial intelligence (AI) model stored in the memory 304. The predefined operating rule or the AI model is provided through training or learning. The one or more processors 302 may execute instructions stored in the memory, individually or collectively.

The one or more processors 302 may be disposed in communication with one or more input/output (I/O) devices via the I/O interface 308. The I/O interface 308 may include a radio frequency (RF) transceiver, a baseband processor capable of performing RSMA-specific signal processing (e.g., rate splitting, precoding, and successive interference cancellation), and a high-speed data interface to communicate with the system's control logic and memory. The I/O interface 308 may include a software-defined Medium Access Control layer (MAC) layer to support dynamic user scheduling and resource allocation in accordance with RSMA principles.

The memory 304 may be configured to store instructions executable by the one or more processors 302. In one embodiment, the memory 304 may communicate via a bus within the system 208. The memory 304 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 304 may include a cache or random-access memory (RAM) for the one or more processors 302.

The memory 304 may be separate from the one or more processors 302 such as a cache memory of a processor, the system memory, or other memory. The memory 304 may be an external server or a database for storing data. The memory 304 may be operable to store instructions executable by the one or more processors 302. The functions, acts, or tasks illustrated in the figures or described may be performed by the programmed processor for executing the instructions stored in the memory 304. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In an embodiment, the memory 304 may include the one or more GenAI models 210a, 210b . . . 210n. The memory 304 may further include data 312 that may serve, amongst other things, as a repository for storing data processed, received, and generated by one or more of the one or more modules 310.

The one or more modules 310, amongst other things, may include routines, programs, objects, components, data structures, etc., which perform particular tasks or implement data types. The module(s) 310 may also be implemented as signal processor(s), state machine(s), logic circuitries, and/or any other device or component that manipulates signals based on operational instructions.

The one or more modules 310 may be implemented in hardware, instructions executed by a processing unit, or by a combination thereof. The processing unit may comprise a computer, a processor, such as the one or more processors 302, a state machine, a logic array, or any other suitable devices capable of processing instructions.

The processing unit may be a general-purpose processor that executes instructions to cause the general-purpose processor to perform the required tasks or, the processing unit may be dedicated to performing the required functions. In another embodiment of the disclosure, the one or more modules 310 may be machine-readable instructions (software) which, when executed by a processor/processing unit 302, perform any of the described functionalities.

In an embodiment, the one or more modules 310 may include a hint detecting module 316, a hint validating module 318, a memory demand and priority level determining module 320, a memory reclaimer selecting module 322, a memory reclamation process initiating module 324, and a reclaimed memory allocating module 326.

In an embodiment, the hint detecting module 316, the hint validating module 318, the memory demand and priority level determining module 320, the memory reclaimer selecting module 322, the memory reclamation process initiating module 324, and the reclaimed memory allocating module 326 may be in communication with each other.

In an embodiment, the hint detecting module 316 may be configured to detect the one or more hints indicating the task to be performed using the one or more GenAI models 210a, 210b . . . 210n. In an embodiment, the hint signal (hereinafter referred to as ‘hint’) may be a pre-detectable signal indicating that the user is likely to initiate a GenAI model launch. Further, the hint detecting module 316 may be configured to identify launch of the GenAI application 212 to wake up a monitoring service. The monitoring service may be a background component that becomes active upon detection of specific triggers, such as the launch of the GenAI application 212 at the user device 202. The monitoring service may monitor memory pressure and available system resources. Furthermore, the hint detecting module 316 may be configured to detect presence of a specific type of icon rendered on the user device 202 based on the identified launch. The specific type of icon may refer to a graphical symbol or User Interface (UI) element rendered on a user interface that represents the launch or presence of the GenAI application 212.

In an embodiment, based on the presence of being detected the specific type of icon, the hint detecting module 316 may be configured to determine the presence of the specific type of icon as the hint signals and notify the presence of the specific type of icon, to a user of the user device 202 before executing the task.

The hint validating module 318 may be configured to validate the one or more detected hints by at least one condition related to a task execution status, authorization of the GenAI application 212 associated with the one or more GenAI models 210a, 210b . . . 210n, or threshold time between memory reclamations. For example, validating a session based on a session status or a previously recorded session timeframe before determining the memory demand.

The task execution status may indicate an operational state of the task that intends to use the GenAI application 212. The task execution status may indicate whether a specific GenAI-related task is pending, ongoing, paused, or completed. The system 208 may ensure that memory reclamation is necessary only when the task is about to run or is already running by checking the task execution status. As a result, the system 208 may prevent unnecessary memory operations.

Further, the authorization of the GenAI application 212 may refer to verifying whether the GenAI application 212 requesting memory or access to one or more GenAI models 210a, 210b . . . 210n has the required system-level privileges, permissions, or trust level to initiate high-memory tasks.

The hint validating module 318 may be configured to analyze the one or more detected hints to determine whether the one or more detected hints correspond to a valid GenAI application. Upon determining that the GenAI application 212 is the valid GenAI application, the hint validating module 318 may be configured to verify whether a predefined (e.g., defined) threshold time has elapsed since a previous GenAI memory reclamation operation based on the GenAI application being determined as valid. The hint validating module 318 may be configured to determine the one or more detected hint signals as valid only when the defined threshold time has elapsed. For example, checking if a minimum amount of time has passed since the last GenAI memory reclamation may be performed. The check may ensure that memory reclamation operations are not performed too frequently, which could destabilize system performance or result in inefficient memory usage. In an example scenario, at 9:00 AM, one or more memory reclaimers are triggered due to a large language model (LLM) execution. At 09:04 AM, the GenAI application 212 attempts to load a different model. The system 208 checks the last memory reclamation timestamp (9:00 AM) and finds that only 4 minutes have passed. Since this is less than the 10-minute threshold, the system 208 blocks or delays a new memory reclamation cycle.

In an embodiment, the memory demand and priority level determining module 320 may be configured to determine the memory demand and the priority level for the task to be performed based on the validated one or more detected hints.

The memory reclaimer selecting module 322 may be configured to select the one or more memory reclaimers based on the determined memory demand and the priority level. The one or more memory reclaimers may include, but are not limited to, a Least Recently Used (LRU), file cache, swamp, Random Access Memory plus, or custom user-space reclaimer.

The GenAI application 212 may require an amount of memory to load and run the one or more GenAI models 210a, 210b . . . 210n. The priority level may indicate importance or urgency associated with the task of the GenAI application 212. In an example scenario, if the memory demand is lower than a threshold amount of memory and the priority level is moderate to the threshold amount of memory, only a Multi-Generational Least Recently Used (MGLRU) aging and page cache dropping may be triggered. The threshold amount of memory may refer to a minimum amount of free and contiguous memory that may be available in the RAM to successfully load and execute the one or more GenAI models 210a, 210b . . . 210n. Further, if the memory demand is high and the one or more memory reclaimers may be used to kill or reclaim memory from the non-GenAI applications.

In an embodiment, the memory reclamation process initiating module 324 may be configured to swap out memory of one or more processes. The one or more processes may include, but are not limited to, collecting running process list, excluding select system and foreground process, swapping out the memory from background processes, and the like. The memory of the one or more processes may be swapped out depending on the priority level associated with the task to free up contiguous memory required for loading the one or more one or more GenAI models 210a, 210b . . . 210n. The memory reclamation process initiating module 324 may be configured to use the one or more selected memory reclaimers. The memory swapping and reclamation may be performed in one or more threads, enabling parallel execution for faster results. The memory swapping and the reclamation may continue until the threshold amount of memory is achieved.

Further, the memory reclamation process initiating module 324 may be configured to maintain (e.g., store) a record of the swapped out memory. The memory reclamation process initiating module 324 may be configured to enable, based on the record of the swapped out memory, restoration of the memory to the respective list of low-priority applications upon completion of the task associated with the GenAI application 212. Upon enabling the restoration of the memory, the memory reclamation process initiating module 324 may be configured to perform one or more adaptive memory reclamation strategies configured to selectively release the memory based on the application state and the memory demand.

The one or more adaptive memory reclamation strategies may include, but are not limited to, priority-based process eviction, MGLRU, cache dropping with control, page compression and write book, selective reclamation of older generations, and the like. The priority-based process eviction may include identifying low-priority or background applications, i.e., the non-GenAI applications.

The MGLRU may include accelerating the aging of one or more memory pages belonging to idle or suspended applications. The cache dropping with control may include dropping a non-essential file or caches (e.g., recycle bin, thumbnail cache). The page compression and write book may include compressing the one or more memory pages of running applications if the applications are idle.

The memory reclamation process initiating module 324 may be configured to initiate the memory reclamation process using the selected one or more memory reclaimers. The memory reclamation process initiating module 324 may be configured to perform one or more memory compaction techniques to defragment the memory. The one or more memory compaction techniques may refer to system-level processes aimed at reducing fragmentation of the memory by reorganizing the physical memory layout to create larger contiguous blocks of free memory. The one or more memory compaction techniques may be useful where large contiguous allocations (e.g., for the one or more GenAI models 210a, 210b . . . 210n or GPU memory) are required, and the memory need to be fragmented into small and non-contiguous chunks.

Further, the memory reclamation process initiating module 324 may be configured to generate a continuous block of free memory based on the performed one or more memory compaction techniques. Upon generating the continuous block of free memory, the memory reclamation process initiating module 324 may be configured to notify the GenAI application 212 that the memory reclamation is complete.

Upon receiving a request to execute the task, the reclaimed memory allocating module 326 may be configured to allocate reclaimed memory associated with the memory reclamation process to the task. Further, the reclaimed memory allocating module 326 may be configured to detect termination of an operation associated with the GenAI application 212 based on a transition to a home screen associated with the GenAI application 212 or an application switch event. Further, the reclaimed memory allocating module 326 may be configured to update memory allocation following the termination of the task associated with GenAI application 212. Upon updating the memory allocation, the reclaimed memory allocating module 326 may be configured to unload the one or more GenAI models 210a, 210b . . . 210n from the memory in response to a memory pressure condition triggered by the one or more non-GenAI applications.

The system 208 may be configured to detect that the GenAI application 212 is present in foreground using an application launch or switch listener. The system 208 may be configured to initiate an MGLRU aging technique in response to detecting the GenAI application 212. Furthermore, the system 208 may be configured to perform proactive aging of memory pages by comparing a current generation pool with a previous generation pool based on the initiated MGLRU aging technique. Upon performing the proactive aging of memory pages, the system 208 may be configured to determine whether to continue aging based on a predefined (e.g., defined) threshold. Further, the system 208 may be configured to trigger the one or more memory reclaimers to reclaim memory pages that satisfy an aging condition based on the determined continue aging.

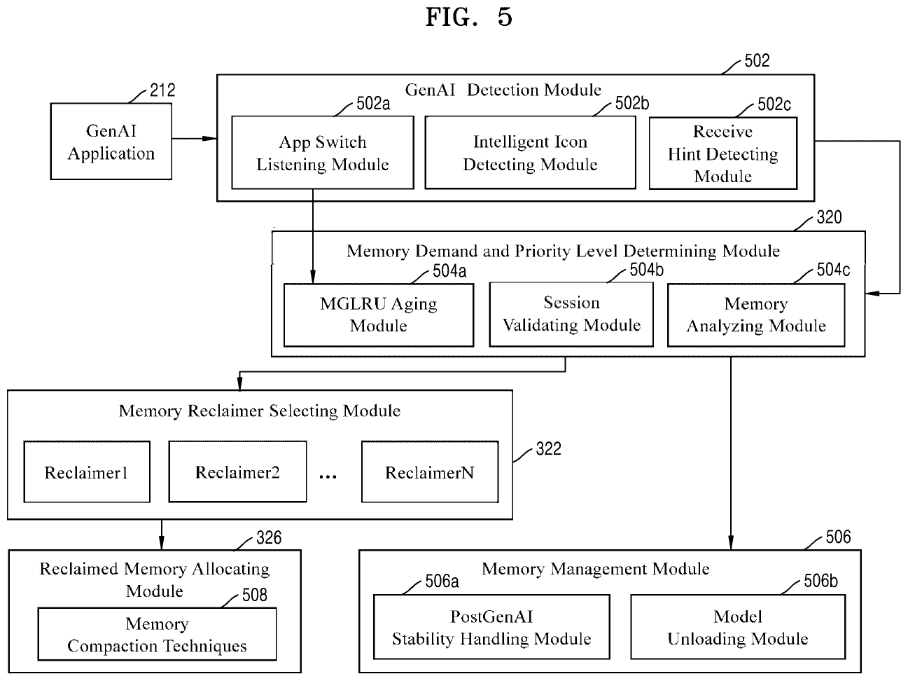

The system 208 may include a hint-based memory management engine 328 that proactively reclaims the memory from running processes upon receiving early signals from the genAI application 212. The hint-based memory management engine 328 may be configured to help in reducing genAI model load times. The hint-based memory management engine 328 is described in greater detail in conjunction with FIGS. 5, 6, and 7 in the forthcoming paragraphs.

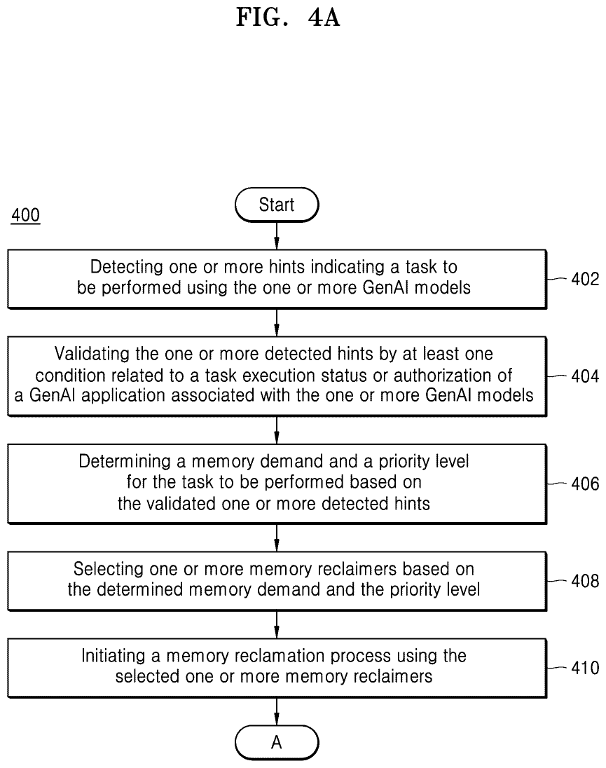

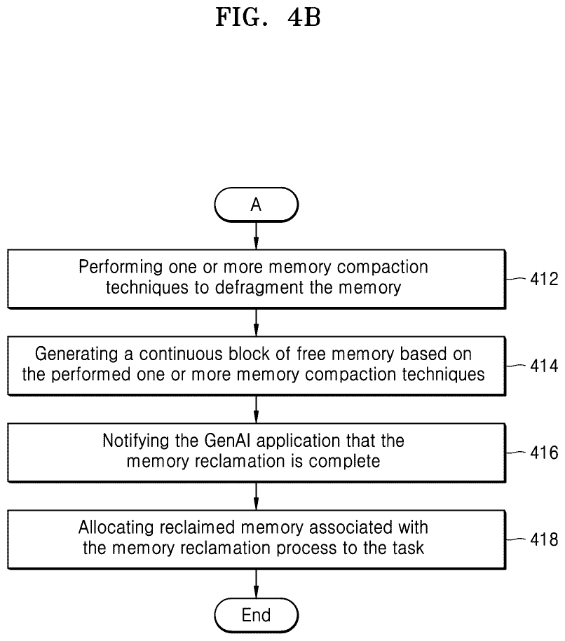

FIGS. 4A and 4B illustrate a flowchart depicting a method 400 for allocating the reclaimed memory associated with the memory reclamation process to the task, according to an embodiment of the disclosure.

The method 400 may be a computer-implemented method executed, for example, by the one or more processors 302 and the module(s) 310. For the sake of brevity, constructional and operational features of the system 208 that are already explained in the description of FIGS. 1A, 1B, 2, and 3 are not explained in detail in the description of FIGS. 4A and 4B.

The method 400 may begin with operation 402 which may include detecting the one or more hints indicating the task to be performed using the one or more GenAI models 210a, 210b . . . 210n.

The hint detecting module 316 may scan the GenAI application 212 to identify if the task is about to start. The scanning of the GenAI application 212 may include monitoring foreground application transitions, identifying UI changes (e.g., presence of a GenAI icon), or API call triggers. In an example, the user opens a photo gallery and taps on a magic erase icon, the system 208 detects the magic erase icon as a hint.

At operation 404, the method 400 may include validating the one or more detected hints by at least one condition related to the task execution status or authorization of the GenAI application 212 associated with the one or more GenAI models 210a, 210b . . . 210n.

The system 208 may check if the one or more detected hints are currently authorized, the GenAI application 212 is in a valid execution state (not paused, not already under memory pressure). For example, the magic erase feature may be available if the user is online and logged in.

At operation 406, the method 400 may include determining the memory demand and the priority level for the task to be performed based on the validated one or more detected hints.

Once the one or more detected hints are validated, the system 208 estimates the amount of memory required to load the one or more GenAI models 210a, 210b . . . 210n (for e.g., 3 GB). The system 208 also assigns the priority level to the task (e.g., high, if the task is a foreground interactive task). In an example, the one or more GenAI models 210a, 210b . . . 210n for the magic erase feature require 2.5 GB, and since it is a real-time user request, the magic erase feature is assigned high priority.

At operation 408, the method 400 may include selecting the one or more memory reclaimers based on the determined memory demand and the priority level.

Based on the determined memory demand and priority level, the system selects the one or more memory reclaimers. In an example scenario, if 1 GB needs to be cleared quickly, the system 208 may use the one or more reclaimers for foreground applications and older background processes.

At operation 410, the method 400 may include initiating the memory reclamation process using the selected one or more memory reclaimers.

The selected one or more memory reclaimers are invoked in the one or more threads. The selected one or more memory reclaimers begin freeing memory by compressing, dropping caches, or evicting old or low-priority application pages. In an example scenario, the one or more memory reclaimers evict the memory pages from long-idle social media applications and drop thumbnail cache data.

At operation 412, the method 400 may include performing the one or more memory compaction techniques to defragment the memory.

After reclaiming the memory, the one or more memory compaction techniques are used to rearrange the memory blocks, eliminate fragmentation, create large contiguous blocks required for the loading of the GenAI models 210a, 210b . . . 210n. For example, compacting memory ensures a 3 GB block is made available in one region for fast loading of the one or more GenAI models 210a, 210b . . . 210n.

At operation 414, the method 400 may include generating the continuous block of free memory based on the performed one or more memory compaction techniques.

A successful compaction results in a large block of free memory. A 3.5 GB continuous chunk is now available in Random Access Memory (RAM).

Upon generating the continuous block of free memory, at operation 416, the method 400 may include notifying the GenAI application 212 that the memory reclamation is complete.

The system 208 sends a signal or intent to the GenAI application 212 that memory is now ready. For example, the GenAI application 212 receives a callback that the memory is ready, and the GenAI application 212 proceeds to load the one or more GenAI models 210a, 210b . . . 210n.

Upon receiving the request to execute the task, at operation 418, the method 400 may include allocating the reclaimed memory associated with the memory reclamation process to the task.

The task associated with the GenAI application 212 is now executed using the allocated memory. The task execution may include loading the load the one or more GenAI models 210a, 210b . . . 210n into the memory and performing inference. For example, a “Magic Erase” model is loaded, and the background of a photo is removed instantly.

In an embodiment, for detecting one or more hints, the method 400 may include identifying launch of the GenAI application 212 to wake up the monitoring service. Further, the method 400 may include detecting presence of the specific type of icon rendered on the user device 202 based on the identified launch. Upon detecting the presence, the method 400 may include detecting the one or more hints and notifying the presence of the specific type of icon, to the user before executing the task.

In an embodiment, for validating the one or more detected hints, the method 400 may include analyzing the one or more detected hints to determine whether the one or more detected hints correspond to the valid GenAI application. Upon determining that the GenAI application 212 is the valid GenAI application, the method 400 may include verifying whether a predefined (e.g., defined) threshold time has elapsed since a previous GenAI memory reclamation operation.

In an embodiment, for initiating the memory reclamation process, the method 400 may include swapping out the memory of the one or more processes depending on the priority level associated with the task, using the one or more selected memory reclaimers, in the one or more threads, until the threshold amount of memory is achieved for loading the one or more GenAI models 210a, 210b . . . 210n. The method 400 may include maintaining (e.g., storing) the record of the swapped out memory to enable restoration of the memory to the respective list of low-priority applications upon completion of the task associated with the GenAI application 212. Upon enabling the restoration of the memory, the method 400 may include performing the one or more adaptive memory reclamation strategies configured to selectively release the memory based on the application state and the memory demand.

Further, in an embodiment, for initiating the memory reclamation process, the method 400 may include performing the one or more memory compaction techniques to defragment the memory. The method 400 may include generating a continuous block of free memory based on the performed one or more memory compaction techniques. Upon generating the continuous block of free memory, the method 400 may include notifying the GenAI application 212 that the memory reclamation is complete.

The method 400 may include detecting the termination of the task associated with the GenAI application 212 based on the transition to the home screen associated with the GenAI application 212 or the application switch event. The method 400 may include updating the memory allocation following the termination of the task associated with the GenAI application 212. Upon updating the memory allocation, the method 400 may include unloading the one or more GenAI models 210a, 210b . . . 210n from the memory in response to a memory pressure condition triggered by one or more non-GenAI applications.

The method 400 may include detecting that the GenAI application 212 is present in foreground using the application launch or the switch listener. The method 400 may include initiating the MGLRU aging technique in response to detecting the GenAI application 212. The method 400 may include performing the proactive aging of memory pages by comparing the current generation pool with the previous generation pool based on the initiated MGLRU aging technique. Upon performing the proactive aging of memory pages, the method 400 may include determining whether to continue aging based on the predefined (e.g., defined) threshold. The method 400 may include triggering the one or more memory reclaimers to reclaim the memory pages that satisfy the aging condition based on the determined continue aging.

FIG. 5 illustrates a block diagram depicting an embodiment of the hint-based memory management engine 328, according to an embodiment of the disclosure.

The hint-based memory management engine 328 may include a GenAI detection module 502, the memory demand and priority level determining module 320, a memory management module 506, the memory reclaimer selecting module 322, and the reclaimed memory allocating module 326.

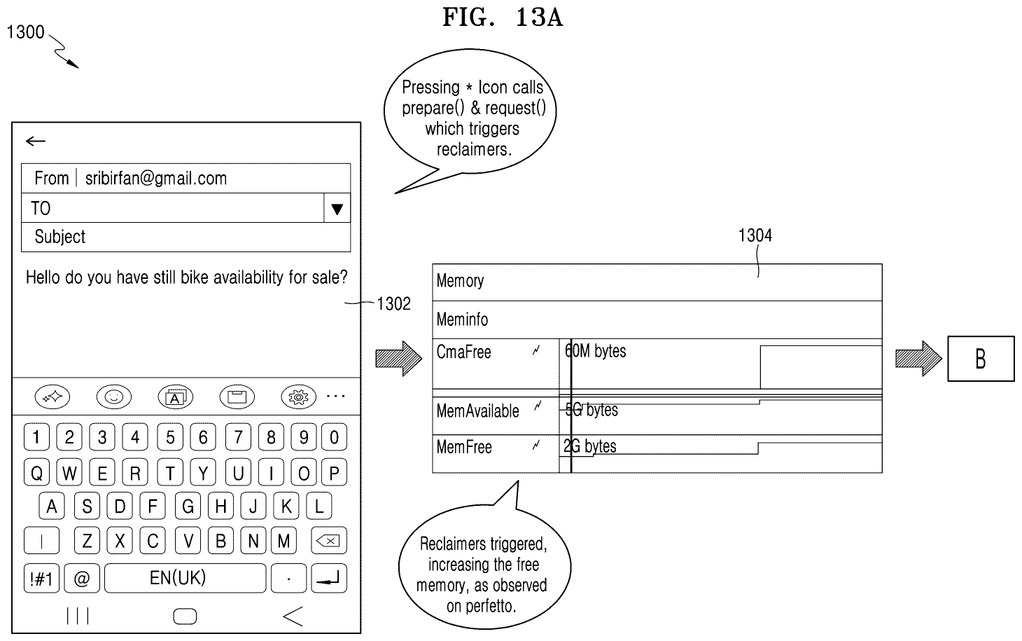

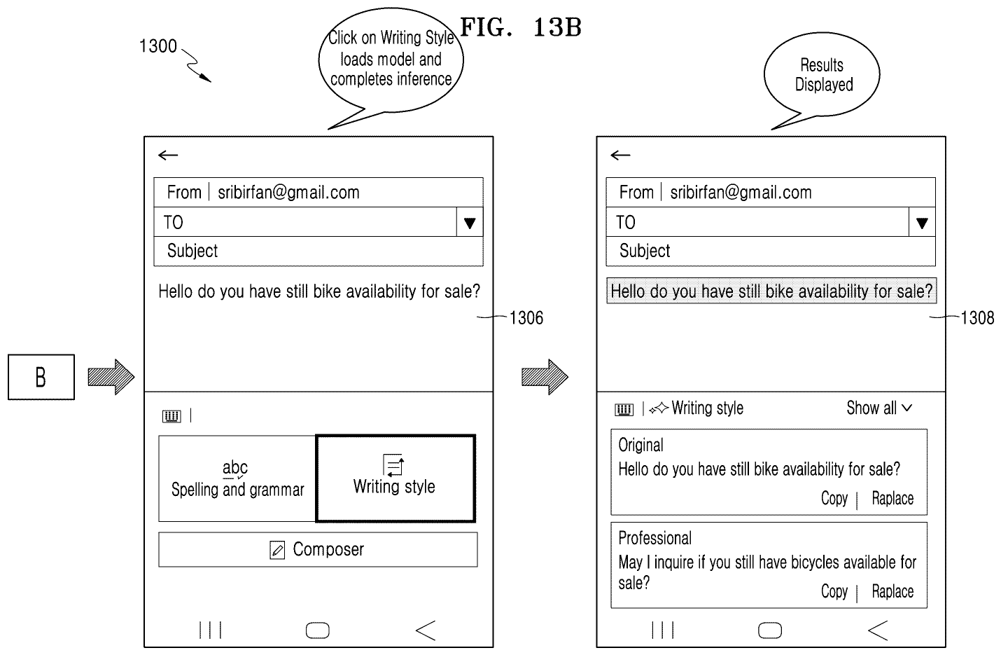

The GenAI detection module 502 may be configured to analyze whether the GenAI application 212 has GenAI use cases. The GenAI use cases are described in greater detail in conjunction with FIGS. 13A, 13B, 14, 15A, 15B, 16A, 16B, 17A, 17B, 18, 19, and 20 in the forthcoming paragraphs.

In an embodiment, the GenAI detection module 502 may include an app switch listening module 502a, an intelligent icon detecting module 502b, and a receive hint detecting module 502c.

In an embodiment, the GenAI detection module 502 may be configured to analyze the currently running or launching GenAI application 212 to determine whether the GenAI application 212 includes or initiates any task that requires large memory allocation, particularly for the one or more GenAI models 210a, 210b . . . 210n. The GenAI detection module 502 may include a window changed listener, a view hierarchy dumper, a view hierarchy parser, and an icon detection logic to analyze the GenAI application 212. The window changed listener may be a monitoring component that tracks application window transitions on the user device 202 to help determine a state and lifecycle of the GenAI application 212. For example, the window changed listener detects when the user switches from one application window to another, i.e., foreground application changes. The window changed listener checks if the foreground application is the GenAI application 212. The view hierarchy dumper may be a collection of components on a screen visible to the user. The components may include, but are not limited to, buttons, layouts, and the like. The view hierarchy parser may parse the components and the icon detection logic may find the presence of a GenAI button.

The intelligent icon detecting module 502b may be configured to scan a screen associated with the GenAI application 212 for an intelligent icon. If the intelligent icon is present, the receive hint detecting module 502c may be configured to take the hint for required memory.

The app switch listening module 502a may be configured to check if a memory reclaimer is already running for another GenAI use case. Furthermore, the app switch listening module 502a may be configured to check the one or more memory reclaimers triggered within a threshold cut-off time. The GenAI detection module 502 may be configured to use the memory demand and priority level determining module 320 for notifying the system 208 before executing the task associated with the GenAI application 212.

In an embodiment, the memory demand and priority level determining module 320 may include a MGLRU aging module 504a, a session validating module 504b, and a memory analyzing module 504c. The MGLRU aging module 504a may be configured to efficiently reclaim memory by aging and identifying least-used memory pages in accordance with the MGLRU aging technique.

Further, the MGLRU aging module 504a may be configured to implement the MGLRU aging technique to classify the memory pages into generations based on usage frequency and recency. In an example scenario, when the system 208 identifies the launch of the GenAI application, the MGLRU aging module 504a is invoked to begin memory analysis and freeing.

The session validating module 504b may be configured to validate the session by checking the session status and the previously recorded session timeframe. Further, the memory analyzing module 504c may be configured to analyze the one or more hints to determine the memory demand and the priority level of the requesting GenAI application. In an example, if a GenAI model is already loaded within past X seconds for the same GenAI application, avoid repeating the memory reclamation process.

In an embodiment, the memory reclaimer selecting module 322 may be configured to fetch running low-priority processes and sort based on a reclamation estimate. The memory reclaimer selecting module 322 may be configured to reclaim the memory from the low-priority processes as per the memory demand using a multithreaded pool. The multithreaded pool may be configured to swap out anonymous memory to ZRAM, where each thread may perform for one process.

The memory reclaimer selecting module 322 may be configured to maintain a record of reclaimed memory to facilitate restoration post-completion of a genAI operation. Furthermore, the memory reclaimer selecting module 322 may be configured to utilize the one or more adaptive memory reclamation strategies to ensure the memory is freed efficiently while maintaining an operational state of GenAI application 212.

The reclaimed memory allocating module 326 may be configured to apply the one or more memory compaction techniques 508 to defragment the memory and ensure contiguous free memory availability. Further, the reclaimed memory allocating module 326 may be configured to notify the GenAI application 212 to ensure the reclaimed memory is allocated and the task of the GenAI application 212 is handled efficiently.

The memory management module 506 may be configured to detect the task execution status through a home Screen or an application switch execution. In an embodiment, the memory management module 506 may include PostGenAI stability handling module 506a and a model unloading module 506b. The PostGenAI stability handling module 506a may be configured to dynamically adjust the memory allocation to maintain stability of the system 208 after executing the task associated with the GenAI application 212. The model unloading module 506b may be configured to unload the memory of the one or more GenAI models 210a, 210b . . . 210n in response to the memory pressure condition triggered by the one or more non-GenAI applications.

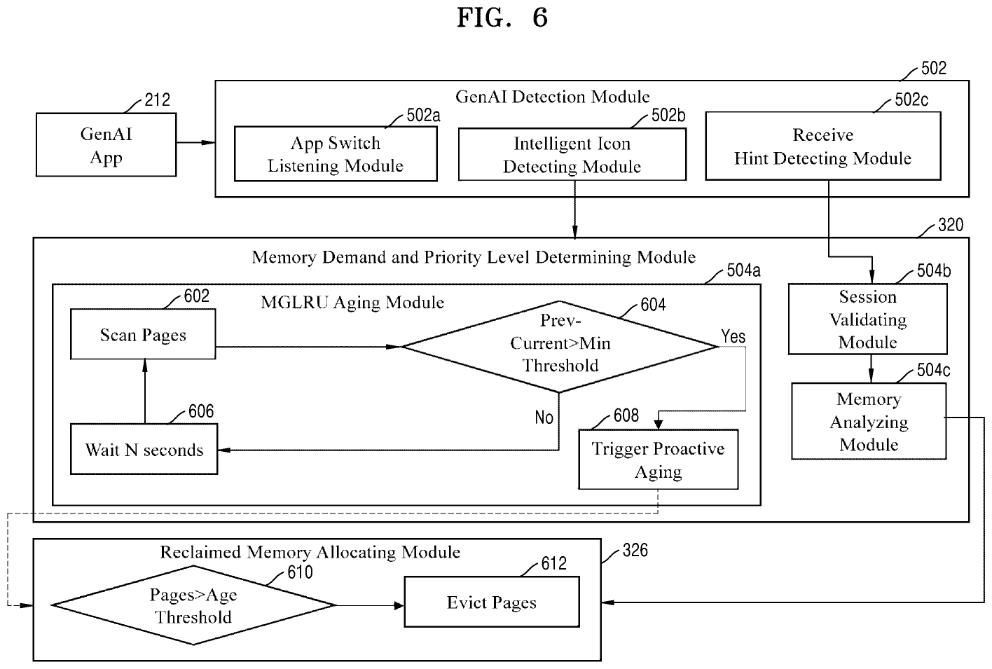

FIG. 6 illustrates a block diagram depicting an embodiment of the hint-based memory management engine 328, according to an embodiment of the disclosure.

In an embodiment, upon detection of the GenAI application 212 on the screen of the user device 202, the GenAI detection module 502 including an app switch listening module 502a, an intelligent icon detecting module 502b, and a receive hint detecting module 502c may be configured to trigger the MGLRU aging module 504a for faster reclamation of the memory pages and launch of the GenAI application 212. The MGLRU aging module 504a in the memory demand and priority level determining module 320 may include a method for performing the proactive aging of memory pages. At operation 602, the method may include scanning the memory pages by the MGLRU aging module 504a. Upon scanning the memory pages, at operation 604, the method may include comparing the current generation pool with the previous generation pool based on the initiated MGLRU aging technique. If the memory pages are not sufficient in the current generation pool, at operation 606, the method 600 may include waiting for a predefined (e.g., defined) threshold duration and reassessing. At operation 608, the method 600 may include performing proactive aging of memory pages if the memory pages in the current generation pool are sufficient.

Upon performing the proactive aging of memory pages, at operation 610, the reclaimed memory allocating module 326 may include determining whether to continue aging based on the predefined (e.g., defined) threshold. At operation 612, the reclaimed memory allocating module 326 may include triggering the one or more memory reclaimers to reclaim the memory pages that satisfy an aging condition based on the determined continue aging. If the aging condition is not satisfied, the method continues at operation 608.

In an embodiment, the session validating module 504b may be configured to validate if a memory request is valid, check if a request is redundant, or reclaimer is already in progress. Further, the session validating module 504b may be configured to check if the request is coming from a GenAI process and check if enough time has passed after the last request (throttle time). Further, the session validating module 504b may be configured to find the free or available memory present in the system 208.

In an embodiment, the memory analyzing module 504c may be configured to analyze the one or more hints to determine the memory demand and the priority level of the requesting GenAI application.

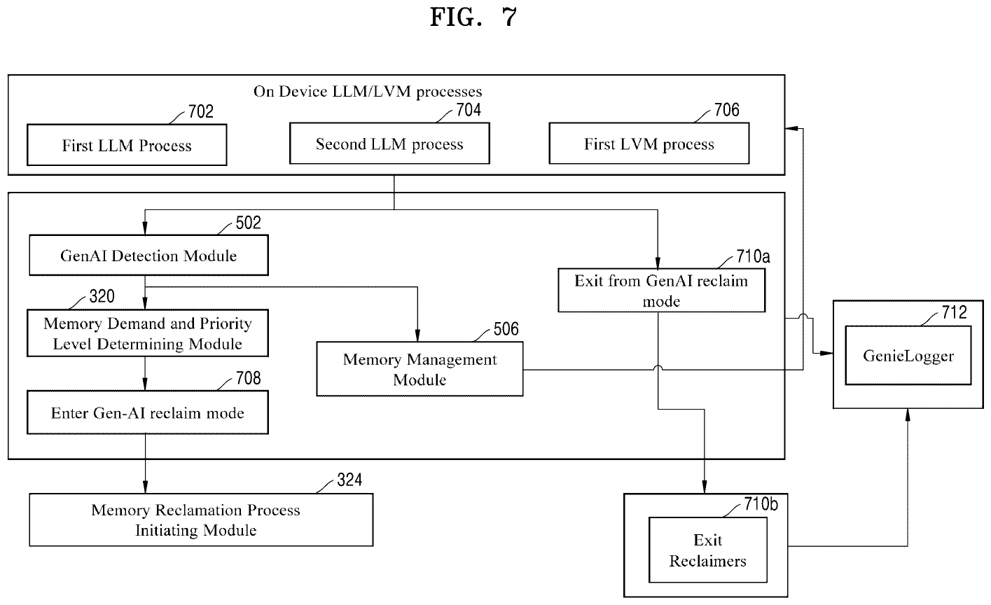

FIG. 7 illustrates an architecture depicting the hint-based memory management engine 328, according to an embodiment of the disclosure.

The hint-based memory management engine 328 may include on-device Large Language Model/Large Vision Model (LLM/LVM) processes, such as a first LLM process 702, a second LLM process 704, and a first LVM process 706. The first LLM process 702 may include Google LLM process (Google.aicore) RO and the second LLM process 704 may include Samsung LLM processes (com.Samsung.android.offline.languagemodel) RC. Further, the first LVM process 706 may include Samsung LVM process (com.Samsung.android.wallpaper.magician).

The GenAI application 212 may use either the LLM processes 702, 704, or LVM process 706 for executing the task. In an embodiment, the GenAI application 212 may send prior hints to the system 208, which would minimize the work of the hint detecting module 316.

Further, the GenAI detection module 502 may be configured to detect a GenAI scenario through scanning the screen and identifying the presence of the intelligent icon. The GenAI detection module 502 may be configured to trigger the memory demand and priority level determining module 320. At block 708, the memory demand and priority level determining module 320 may enter Gen-AI reclaim mode. In an embodiment, the memory demand and priority level determining module 320 may include the MGLRU aging module 504a. The GenAI detection module 502 may be configured to detect the end of the GenAI scenario through listening to events like App-Switch or home screen. Further, the GenAI detection module 502 may be configured to trigger the memory management module 506.

The memory demand and priority level determining module 320 may be configured to determine the amount of free memory currently available in the system 208 by querying the memory management module 506. The memory management module 506 may be configured to calculate a memory requirement by subtracting the free memory from the total memory requested by the GenAI application 212 such that:

Memory Required=Memory Request from GenAI App−Free Memory

The memory reclamation process initiating module 324 may be configured to trigger the one or more memory reclaimers to reclaim the memory pages that satisfy the aging condition based on the determined continue aging. Further, the memory reclamation process initiating module 324 may be configured to ensure availability of contiguous memory for loading of the one or more GenAI models 210a, 210b . . . 210n. The memory reclamation process initiating module 324 may be configured to intelligently manage memory resources by leveraging a combination of multithreaded RAM operations, MGLRU page aging, file-backed memory reclamation, and kernel-level compaction (kCompact). Upon detecting memory demand for the GenAI application 212, the module initiates the one or more reclaimers to parallelize the release of low-priority memory pages, enhancing efficiency and reducing latency.

The memory reclamation process initiating module 324 may be configured to drop caches to free up contiguous memory blocks required for loading the the one or more GenAI models 210a, 210b . . . 210n. Further, the memory reclamation process initiating module 324 may be configured to temporarily block the caches to prevent the caches from being filled again until a GenAI mode or the task is completed. The memory reclamation process initiating module 324 may be configured to initiate reclaimer threads if the reclaimer threads are not already active, to begin reclaiming memory from low-priority or inactive applications.

At block 710a and 710b, the system 208 may be configured to exit from the GenAI mode upon completion of the task. The system 208 may be configured to assess the memory reclamation occurred due to GenAI mode. Further, the system 208 may be configured to intelligently restore the memory of the background applications or the non-GenAI applications based on a usage pattern. Further, the system 208 may be configured to allow cache refill.

The memory management module 506 may be configured to monitor the GenAI processes after the non-GenAI applications are put in the background. Further, the memory management module 506 may be configured to check for the memory pressure condition after executing the task associated with the GenAI application 212. If the memory pressure exceeds the threshold, the memory management module 506 may be configured to identify the least recently used (LRU) GenAI process. Upon identification of the GenAI process, the the memory management module 506 may be configured to unload the one or more GenAI models 210a, 210b . . . 210n associated with the LRU process by terminating or killing the corresponding process to free up the memory.

At block 712, the system 208 may be configured to generate and log diagnostic data, such as dumpstate or bigdata, for analysis and debugging. The system 208 may be configured to collect statistical metrics, including the state of the LMKD before and after the memory reclamation process, to assess the effectiveness of memory management operations.

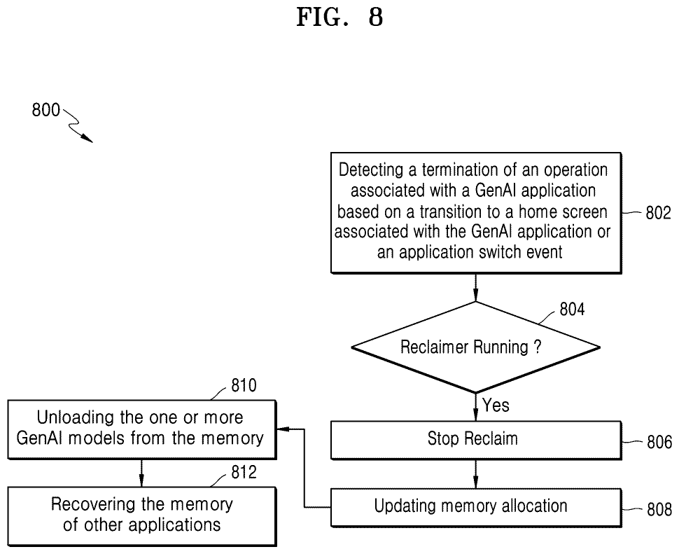

FIG. 8 illustrates a flow diagram depicting a method 800 for performing post-GenAI operations, according to an embodiment of the disclosure.

At operation 802, the method 800 may include detecting, by the GenAI detection module 502, the termination of the task associated with the GenAI application 212. In an embodiment, the GenAI detection module 502 may detecting the termination based on the transition to the home screen associated with the GenAI application 212 or the application switch event.

At operation 804, determining, by the GenAI detection module 502, whether the one or more memory reclaimers are running.

If the one or more memory reclaimers are running, at operation 806, the method 800 may include sending, by the GenAI detection module 502, a signal to the memory reclaimer selecting module 322.

At operation 808, the method 800 may include updating memory allocation following the termination of the task associated with the GenAI application 212.

At operation 810, the method 800 may include unloading the one or more GenAI models 210a, 210b . . . 210n from the memory in response to the memory pressure condition triggered by the one or more non-GenAI applications.

At operation 812, the method 800 may include recovering the memory of the one or more non-GenAI applications caused due to reclaiming and loading of the one or more GenAI models 210a, 210b . . . 210n.

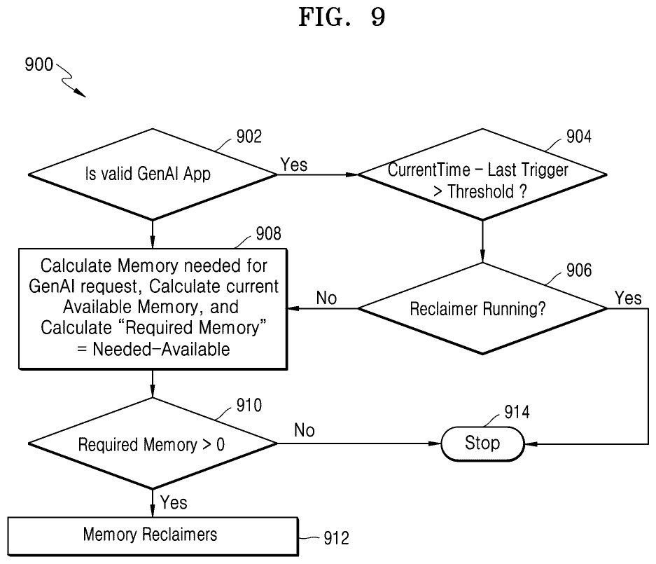

FIG. 9 illustrates a flow diagram depicting a method 900 for validating the one or more detected hints associated with the GenAI application 212, according to an embodiment of the disclosure.

At operation 902, the method 900 may include determining whether the current running application qualifies as the GenAI application 212.

If the application is valid, at operation 904, determining whether a threshold interval has elapsed since a previous GenAI memory reclamation operation, i.e., CurrentTime−LastTriggerTime>Threshold.

At operation 906, determining whether the one or more memory reclaimers are already running for the task associated with the GenAI application 212.

If no memory reclaimer is currently running, at operation 908, the method 900 may include calculating the memory needed for the task associated with the GenAI application 212, calculating current available memory, and deriving required memory, i.e., required memory=memory needed-available memory.

At operation 910, determining whether the required memory is greater than zero.

If the required memory is greater than zero, at operation 912, the method 900 may include triggering the one or more memory reclaimers to reclaim the memory pages.

If the memory reclaimer is running within the threshold, at operation 914, the method 900 may include triggering a stop signal to the memory reclaimer selecting module 322 to terminate an ongoing memory reclaimer.

If the memory reclaimer is currently running, the method 900 may continue at operation 914.

If the required memory is not greater than zero, at operation 914, the method 900 may include triggering a stop signal to the memory reclaimer selecting module 322 to terminate an ongoing memory reclaimer.

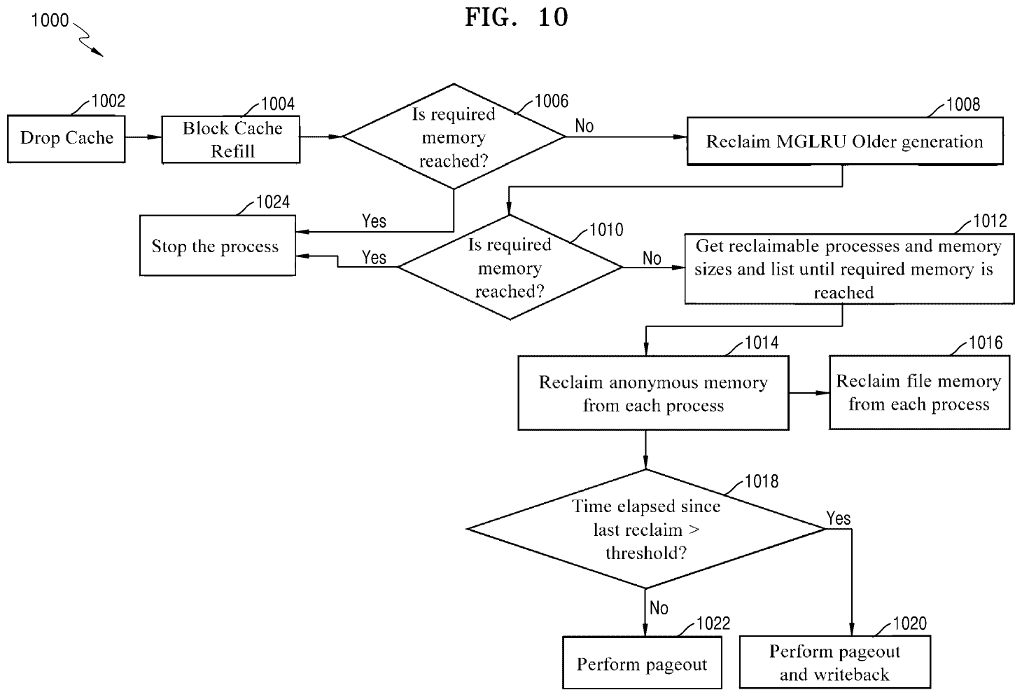

FIG. 10 illustrates a flow diagram depicting a method 1000 for initiating the memory reclamation process, according to an embodiment of the disclosure.

The method 1000 may include three stages, such as cache reclamation, reclaiming older pages via the MGLRU aging module 504a, and reclaiming the memory from processes.

At operation 1002, the method 1000 may include clearing recycle-bin related caches to free up space for contiguous GenAI memory. At operation 1004, the method 1000 may include disabling further filling of recycle bin caches to prevent reclaimed memory from being reused too quickly.

At operation 1006, the method 1000 may include determining whether the required memory is reached.

If the required memory is not reached, at operation 1008, the method 1000 may include reclaiming the memory pages via the MGLRU aging technique.

At operation 1010, determining whether the required memory is reached.

If the required memory is not reached, at operation 1012, the method 1000 may include calculating the memory usage of the one or more processes and identifying the candidates for reclamation.

At operation 1014, the method 1000 may include reclaiming anonymous memory from each process.

At operation 1016, the method 1000 may include reclaiming a file memory from each process.

At operation 1018, the method 1000 may include determining whether the threshold interval has elapsed since a previous GenAI memory reclamation operation.

If the threshold interval has elapsed, at operation 1020, the method 1000 may include performing compression or writeback on the memory pages based on a predetermined time threshold.

If the threshold interval hasn't been elapsed, at operation 1022, the method 1000 may include performing page out.

If the required memory is reached, at operation 1024, the method 1000 may include stopping the memory reclamation process.

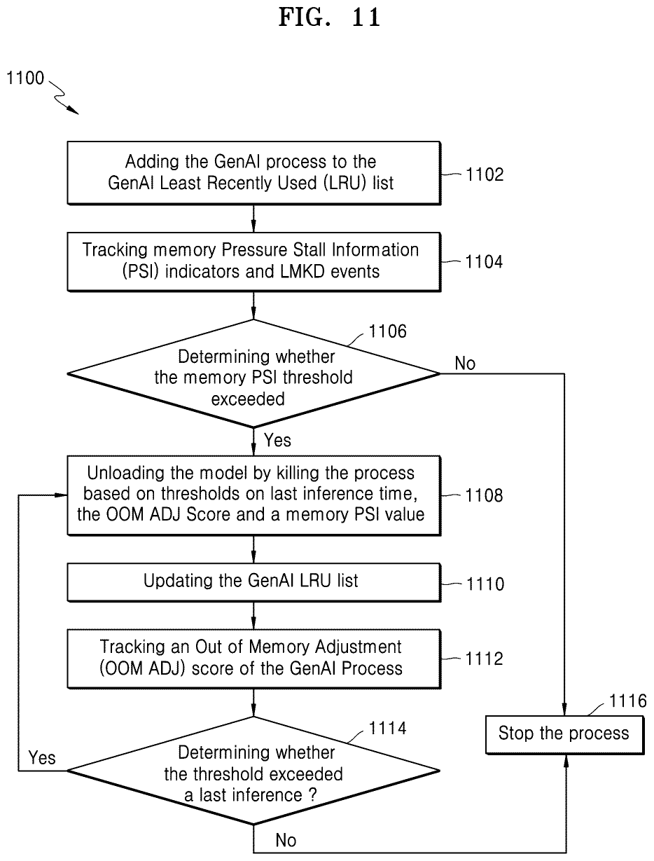

FIG. 11 illustrates a flow diagram depicting a method 1100 for unloading the one or more GenAI models 210a, 210b . . . 210n from the memory, according to an embodiment of the disclosure.

At operation 1102, the method 1100 may include adding the GenAI process to the GenAI Least Recently Used (LRU) list.

At operation 1104, the method 1100 may include tracking memory Pressure Stall Information (PSI) indicators and LMKD events.

At operation 1106, the method 1100 may include determining whether the memory PSI threshold has been exceeded. If the memory PSI threshold has not been exceeded, the method 1100 continue at operation 1116, stopping the process.

If the memory PSI threshold has been exceeded, at operation 1108, the method 1100 may include unloading the model by killing the process based on thresholds on last inference time, the OOM ADJ Score and a memory PSI value.

At operation 1110, the method 1100 may include updating the GenAI LRU list.

At operation 1112, the method 1100 may include tracking an Out of Memory Adjustment (OOM ADJ) score of the GenAI Process.

At operation 1114, the method 1100 may include determining whether the threshold exceeded a last inference. If the threshold time is exceeded, the method 1100 may continue at operation 1108. If the threshold time is not exceeded, the method 1100 may continue at operation 1116, the stopping the unloading the one or more GenAI models 210a, 210b . . . 210n.

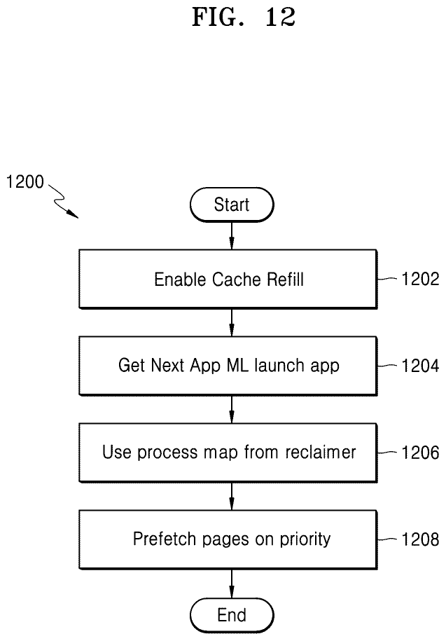

FIG. 12 illustrates a flow diagram depicting a method 1200 for prefetching the memory pages and restore the memory pages by the PostGenAI stability handling module 506a, according to an embodiment of the disclosure.

At operation 1202, the method 1200 may include enabling the filling of caches that are blocked during the reclaim of the memory pages.

At operation 1204, the method 1200 may include analyzing user behavior and app usage patterns to predict which applications the user is likely to launch soon.

At operation 1206, the method 1200 may include using a memory map created during the page out or writeback process to track which pages are evicted and from which processes.

At operation 1208, the method 1200 may include proactively loading the predicted pages back into the memory based on the app launch predictions and the reclaimer map, improving app responsiveness and reducing latency.

FIGS. 13A and 13B illustrate an example use case 1300 for displaying results to the user on the user device 202, according to an embodiment of the disclosure.

At shown in block 1302, the user presses the icon on a virtual keyboard interface. Upon pressing the icon, prepare ( ) and request ( ) functions in turn trigger the one or more memory reclaimers.

At shown in block 1304, the one or more memory reclaimers are executed, and the one or more memory reclaimers increase the amount of free memory. The execution of the one or more memory reclaimers may be monitored and confirmed using a performance tool i.e., Perfetto.

At shown in block 1306, after memory is freed, the user clicks on a writing style option. The writing style option loads the one or more GenAI models 210a, 210b . . . 210n and performs inference, suggesting the transformation of text based on a selected writing style.

At shown in block 1308, results are displayed to the user. The results may be a text suggestion, style enhancement, or AI-generated completion. The system 208 provides a seamless user interface path from user input.

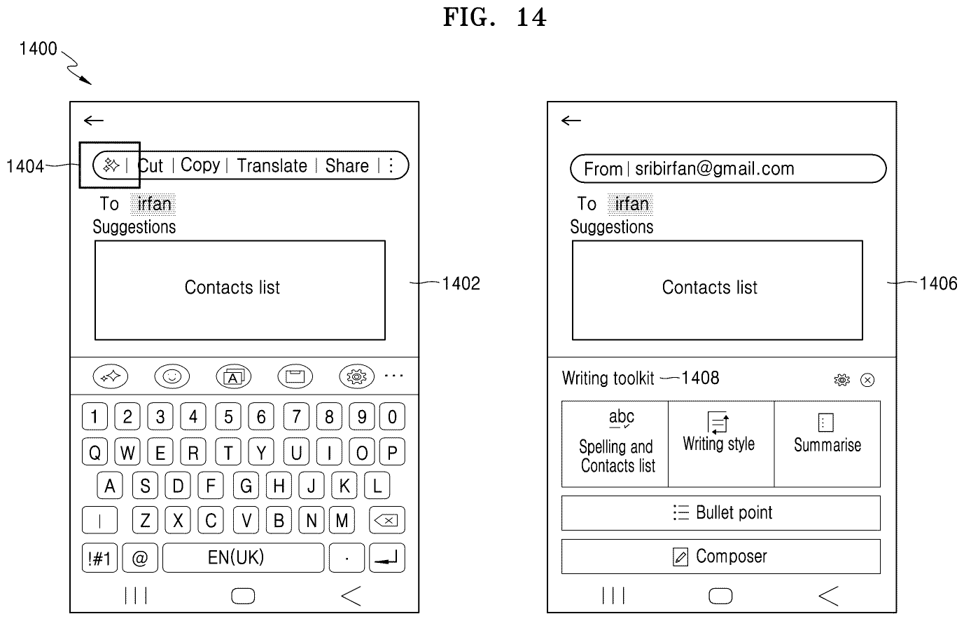

FIG. 14 illustrates an example use case 1400 for triggering an writing assistant within an email composition on the user device 202, according to an embodiment of the disclosure.

At shown in block 1402, a magic icon 1404 which is a common visual cue for activating the writing assistance. When the user taps the magic icon 1404, a genie hint Application Programming Interface (API) may be triggered.

At shown in block 1406, model load and inference may be shown. A writing tool kit 1408 may be appeared at the bottom. After the API is triggered, the one or more GenAI models 210a, 210b . . . 210n load either on-device or remotely.

The writing tool kit 1408 may offer options like spelling and grammar, writing style, summarize, bullet points, and casual or tone options. The writing tool kit 1408 becomes available to the user for improving writing with AI-powered options.

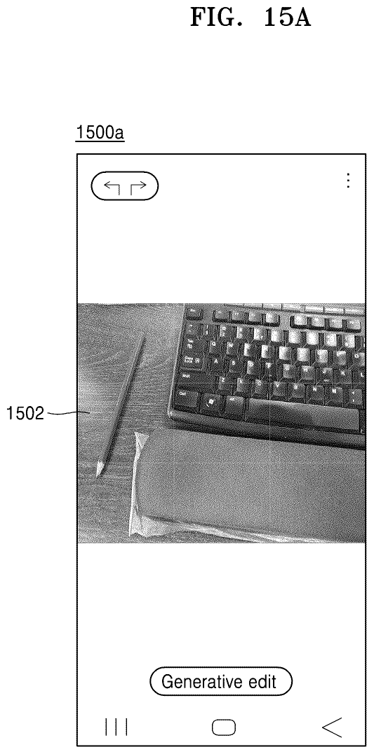

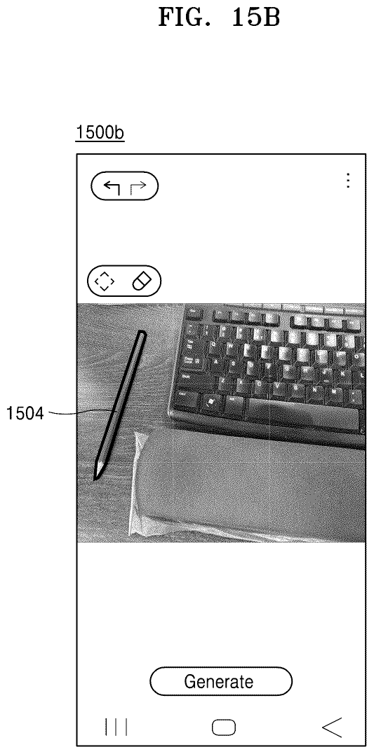

FIG. 15A illustrates an example use case 1500a depicting selecting an original image 1502 on the user device 202 using the one or more GenAI models 210a, 210b . . . 210n, according to an embodiment of the disclosure.

The original image 1502 may include a visually consistent background or surroundings. In the example use case 1500a, the user may select the original image 1502 from a gallery using the one or more GenAI models 210a, 210b . . . 210n.

FIG. 15B illustrates an example use case 1500b depicting marking a pencil image 1504 associated with the original image 1502 in FIG. 15A on the user device 202 using the one or more GenAI models 210a, 210b . . . 210n, according to an embodiment of the disclosure. The pencil image 1504 may be marked for removing from the original image 1502 in FIG. 15A.

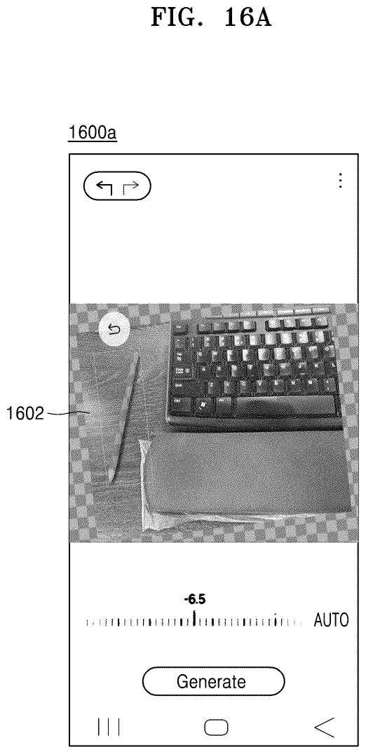

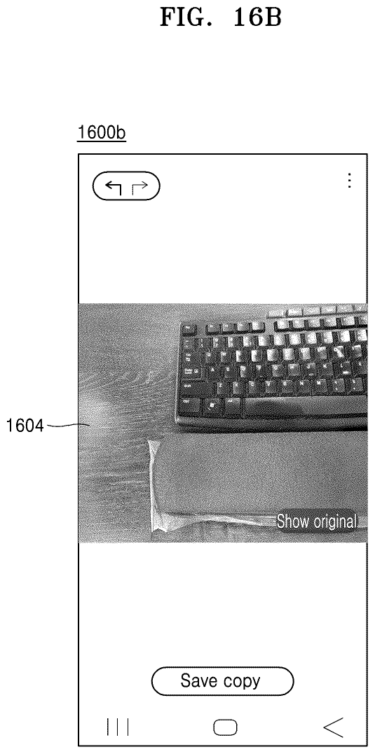

FIG. 16A illustrates an example use case 1600a depicting adjusting background of the original image 1502 in FIG. 15A, according to an embodiment of the disclosure.

For example, by filling in missing background areas or adding objects based on contextual understanding of the original image 1502 in FIG. 15A. The system 208 helps create a more aesthetic or complete visual 1602, especially when preparing pictures for sharing, printing, or framing. The entire operation is performed on-device using the one or more GenAI models 210a, 210b . . . 210n.

FIG. 16B illustrates an example use case 1600b depicting outpainting the background of the original image 1502 in FIG. 15A, where the background of the original image is extended on the user device 202 using the one or more GenAI models 210a, 210b . . . 210n, according to an embodiment of the disclosure.

A GenAI inpainting model may process the marked region and reconstruct an underlying image 1604 by filling in the space with contextually appropriate content, blending the underlying image seamlessly with the surrounding pixels.

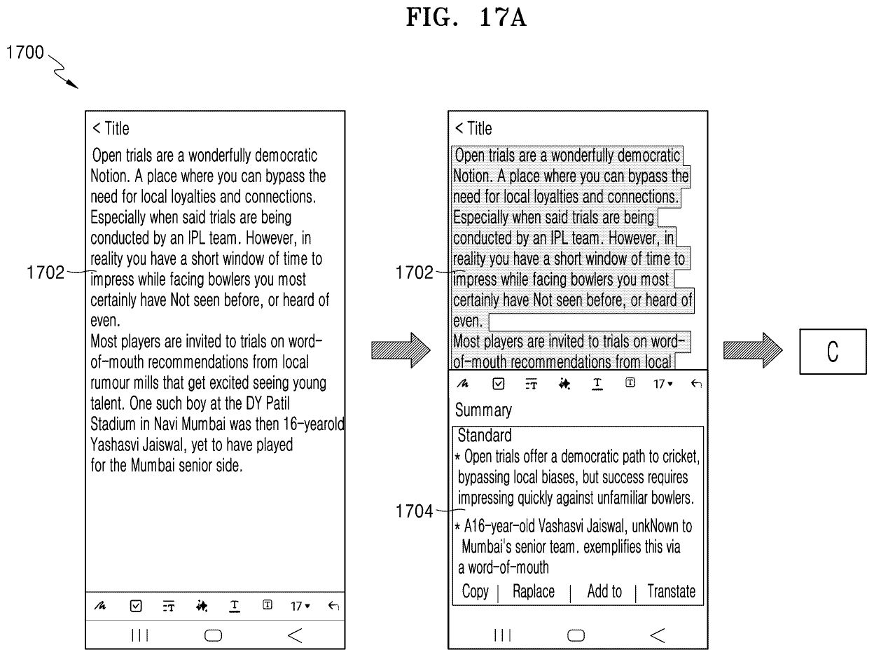

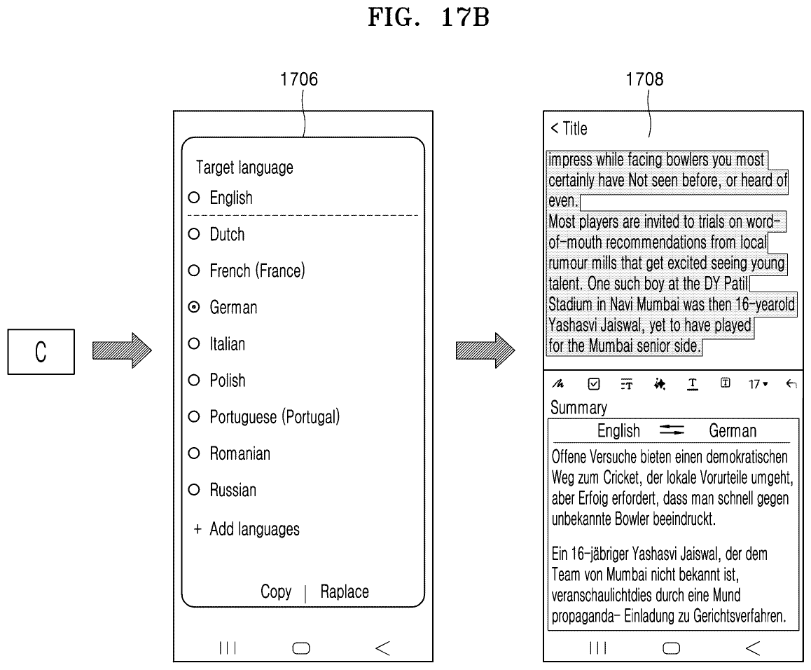

FIGS. 17A and 17B illustrates an example use case 1700 for providing notes intelligence on the user device 202 using the one or more GenAI models 210a, 210b . . . 210n, according to an embodiment of the disclosure.

In the example use case 1700, the user may select a body of text 1702 such as classroom notes, meeting minutes, or handwritten content through a text editor, image-to-text module, or note-taking application. The GenAI application 212 invokes the one or more GenAI models 210a, 210b . . . 210n to process the input content and generate a summarized version of the notes 1704. The summarized version of the notes 1704 may highlight key points, decisions, or learning outcomes, and/or a translated version of the notes 1708 into a different language 1706 specified by the user. The task of the GenAI application 212 ensures user privacy and reduces reliance on cloud services. Such summarization and translation capabilities enable enhanced productivity and accessibility for users, especially in multilingual or academic environments, while maintaining low latency and data security.

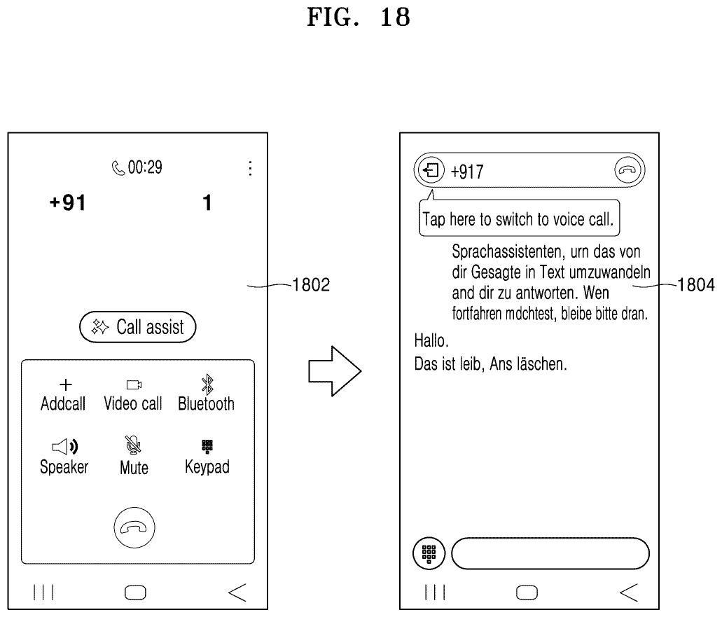

FIG. 18 illustrates an example use case 1800 for providing call translation and summarization on the user device 202 using the one or more GenAI models 210a, 210b . . . 210n, according to an embodiment of the disclosure.

In the example use case 1800, the user device 202 may capture an incoming or outgoing voice call 1802 and stores audio data 1804 locally. The GenAI application 212 on the user device 202 may detect the presence of a recorded voice session and initiate processing through the one or more GenAI models 210a, 210b . . . 210n. The system 208 may execute the following operations. The voice data may be converted into text using the one or more GenAI models 210a, 210b . . . 210n. Further, if an original language differs from user's preferred language, transcribed text may be translated accordingly. The example use case 1800 highlights the ability of the system 208 to leverage one or more GenAI models 210a, 210b . . . 210n efficiently under memory constraints.

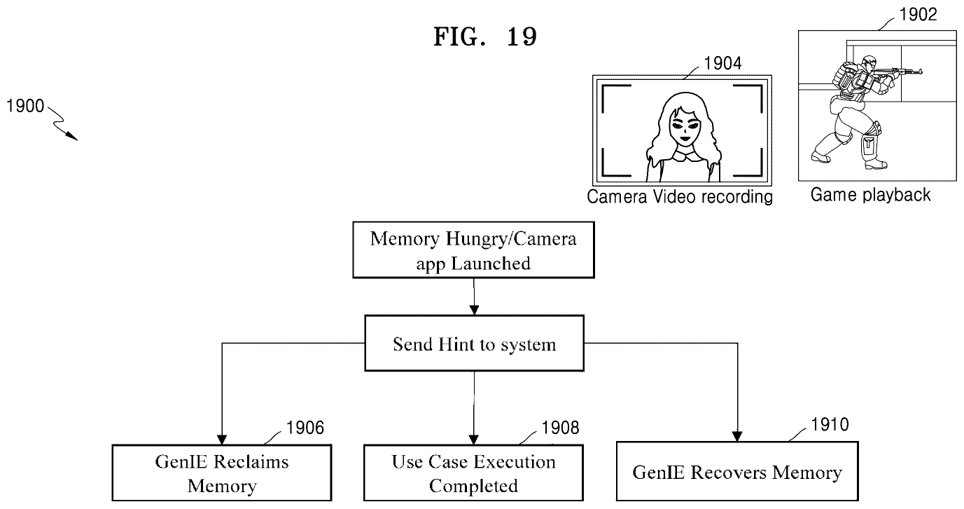

FIG. 19 illustrates an example use case 1900 for improving performance of memory-hungry applications on the user device 202 using the one or more GenAI models 210a, 210b . . . 210n, according to an embodiment of the disclosure.

The memory-hungry applications may include, but are not limited to, a gaming application 1902, a camera application 1904, and the like. A GenAI Execution Infrastructure Engine (GenIE) may facilitate efficient memory management to support execution of or more GenAI models 210a, 210b . . . 210n and associated use cases on resource-constrained user devices.

Upon detecting that the GenAI application 212 is about to be executed, at block 1906, initiating the memory reclamation process. The GenIE determines the memory demand and selectively reclaims memory by identifying and temporarily swapping out low-priority background processes or clearing non-critical cached pages using one or more memory reclaimers. Compaction techniques are applied to ensure contiguous memory availability for Direct Memory Access (DMA) loading of the GenAI model.

At block 1908, loading the one or more GenAI models 210a, 210b . . . 210n and executing the task on the user device 202.

Once the GenAI use case execution is completed, at block 1910, initiating a recovery process. The recovery process may include reloading page caches, restoring application states, and reinitializing suspended services based on usage prediction, thereby ensuring a seamless user experience without prolonged delays or data loss.

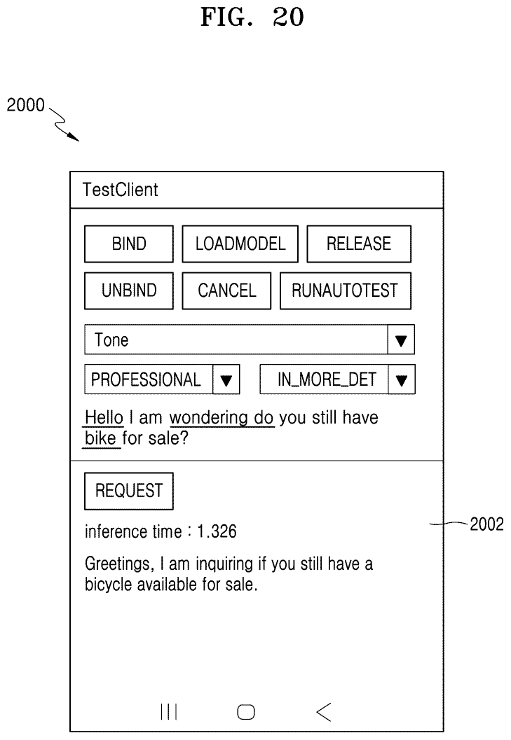

FIG. 20 illustrates a scenario depicting the execution of a GenAI application 2000, according to an embodiment of the disclosure.

The execution of a GenAI application 2000 may showcase memory statistics and performance metrics 2002 recorded during the loading and execution of the one or more GenAI models 210a, 210b . . . 210n by the GenAI application 212. Following the successful loading of the one or more GenAI models 210a, 210b . . . 210n, the system 208 may report,
Memory Free: 889 MB
Memory Available: 1802 MB

The memory available and memory free may indicate that the memory compaction and reclamation processes successfully preserved a considerable amount of available memory, enabling efficient the one or more GenAI models 210a, 210b . . . 210n execution without severely disrupting other processes.

The one or more GenAI models 210a, 210b . . . 210n may be loaded into the memory in approximately 670 milliseconds.
SSNeuralSSNNeuralcore: Duration of ModelLoadandInit_E25:671.734 ms

The overall performance improvement in terms of loading the one or more GenAI models 210a, 210b . . . 210n and execution latency may be measured at approximately 20% compared to baseline scenarios where no proactive memory management may be applied. the execution of a GenAI application 2000 may validate the effectiveness of the disclosure in enabling fast and efficient deployment of memory-intensive the one or more GenAI models 210a, 210b . . . 210n on the user device 202, without offloading to the cloud or degrading user experience for background tasks.

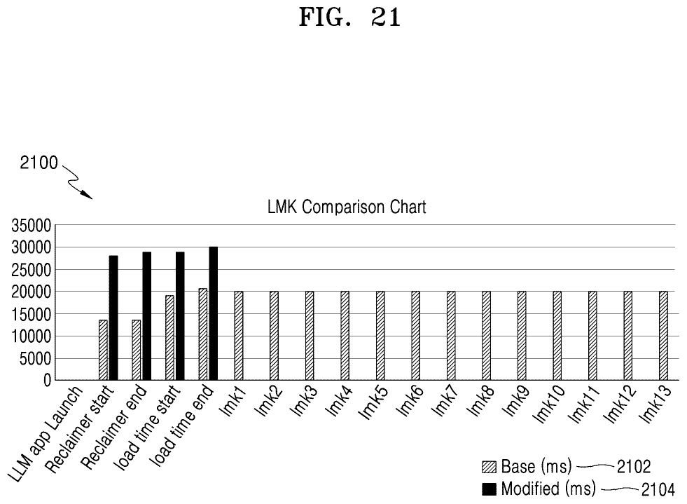

FIG. 21 illustrates a diagram depicting a Low Memory Killings (LMK) comparison chart 2100, according to an embodiment of the disclosure.

The LMK comparison chart 2100 may include a base timeline 2102 and a modified timeline 2104. The base timeline 2102 may represent standard system behavior without GenAI-aware memory management techniques. Further, the modified timeline 2104 may represent behaviour of the system 208 when GenAI memory reclamation, compaction, and intelligent reclaimers are employed as per the disclosure. The base timeline 2102 may demonstrate higher memory pressure as the one or more GenAI models 210a, 210b . . . 210n loaded without any preparatory reclamation. The base timeline 2102 may show multiple LMK events, whereas the modified timeline 2104 may show fewer LMK events.

The Table 1 below may include the LMK events:

TABLE 1

| Events | Base(ms) | Modified(ms) |
|---|---|---|
| LLM app Launch | 0 | 0 |
| Reclaimers start | 13462 | 27837 |
| Reclaimers end | 13848 | 28616 |
| load time start | 19151 | 28880 |
| load time end | 20407(1256) | 29725 (diff: 845) |
| LMK count during model load time | 13 | 0 |

The table 2 below may include list of Key Performance Indicators:

TABLE 2

| KPI | Modified | Base |
|---|---|---|
| LLM Model Load time (ms) | 671 | 807 |
| #pagefaults after relaunching 30 apps | 3812640 | 53844468 |
| pagefault Memory (GB) | 15 | 205 |
| Reclaimed Size (MB) | 1038 | 97 |

The disclosure presents various advantages, which may include:

The disclosure identifies the launch or execution of GenAI applications using icon-based hints or task intent detection.

The disclosure enables proactive memory management, tuned specifically into high-memory workloads typical of GenAI models.

The disclosure intelligently prioritizes less critical processes and leverages machine learning for scoring, a process selection technique that ensures that important user applications remain unaffected while efficiently freeing up memory for GenAI use cases.

The disclosure protects the system stability while supporting demanding AI tasks.

The disclosure triggers Multi-Generational LRU (MGLRU) aging and reclamation selectively for GenAI use cases.

The disclosure ensures high-reclaim efficiency by aging and dropping the least recently used pages or lower-priority applications.

The disclosure enables real-time responsiveness without blocking the User Interface (UI) or delaying user interactions.

The disclosure temporarily drops caches (e.g., recycle bin) and blocks cache refilling to prevent memory wastage during critical AI execution phases.

The disclosure restores useful caches based on predicted app usage.

The disclosure prefetches pages for likely-to-be-used applications based on usage patterns, improving perceived performance and reducing cold starts.

The disclosure avoids false positives and unnecessary reclaim cycles.

The disclosure protects critical applications from reclamation, ensuring the stability of the system and user experience.

The disclosure performs aging when the process is in an idle state after the launch of the application (this is for creation/updating of old/new generation page list).

The disclosure executes the one or more memory reclaimer prior to loading the one or more GenAI models (star detection), and hence there is no conflict with GenAI model loading/inference.

The disclosure solves an Input-Output (IO) conflict with loading of the one or more GenAI models and reclaimer execution to free up memory.

The disclosure explicitly considers a system state such as, Input-Output (IO) conflict avoidance, process selection, reclaimer order optimization, and the like.

The disclosure prevents conflicts between GenAI model loading and reclaimer execution by timing reclamation proactively (when the GenAI model is about to start, a star button appears).

The disclosure targets less critical processes for memory reclamation, avoiding core applications like System UI, Launcher, and system server.

The disclosure executes the memory reclaimers in an order that minimizes system slowdown and maximizes efficiency.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

In accordance with an aspect of the disclosure, a method is provided. The method includes detecting one or more hint signals indicating a task to be performed using the one or more generative artificial intelligence (GenAI) models. In an embodiment, the method includes validating the one or more detected hint signals by at least one condition related to a task execution status or authorization of a GenAI application associated with the one or more GenAI models. In an embodiment, the method includes determining a memory demand and a priority level for the task based on the validated one or more detected hint signals. In an embodiment, the method includes selecting one or more memory reclaimers based on the determined memory demand and the priority level. In an embodiment, the method includes initiating a memory reclamation process using the selected one or more memory reclaimers. In an embodiment, the method includes allocating reclaimed memory associated with the memory reclamation process to the task based on receiving a request to execute the task.

In an embodiment, the one or more hint signals comprise at least one of: a foreground application launch, a system-level application programming interface (API) call, a framework API call, UI changes, or a user interaction indicating execution the task associated with the GenAI application.

In an embodiment, the detecting of the one or more hint signals comprises identifying launch of the GenAI application. In an embodiment, the detecting of the one or more hint signals comprises detecting presence of a specific type of icon rendered on a user device based on the identified launch. In an embodiment, based on the presence being detected, determining the presence of the specific type of icon as the hint signals and notifying the presence of the specific type of icon, to a user before executing the task.

In an embodiment, the validating of the one or more detected hint signals comprises determining whether the one or more detected hint signals correspond to a valid GenAI application. In an embodiment, the validating of the one or more detected hint signals comprises verifying whether a defined threshold time has elapsed since a previous GenAI memory reclamation operation based on the GenAI application being determined as valid. In an embodiment, the validating of the one or more detected hint signals comprises determining the one or more detected hint signals as valid only when the defined threshold time has elapsed.

In an embodiment, the initiating of the memory reclamation process comprises swapping out memory of one or more processes depending on the priority level associated with the task, using the one or more selected memory reclaimers, in one or more threads, until a threshold amount of memory is achieved for loading the one or more GenAI models. In an embodiment, the initiating of the memory reclamation process comprises storing a record of the swapped out memory. In an embodiment, the initiating of the memory reclamation process comprises enabling, based on the record of the swapped out memory, restoration of the memory to a respective list of low priority applications upon completion of the task. In an embodiment, the initiating of the memory reclamation process comprises performing one or more adaptive memory reclamation strategies configured to selectively release the memory based on an application state and the memory demand based on the enabling of the restoration of the memory.

In an embodiment, the initiating of the memory reclamation process comprises defragmenting the memory by performing one or more memory compaction techniques. In an embodiment, the initiating of the memory reclamation process comprises generating a continuous block of free memory based on the defragmented memory. In an embodiment, the initiating of the memory reclamation process comprises notifying the GenAI application that the memory reclamation is complete based on the generation of the continuous block of free memory.

In an embodiment, the method includes detecting termination of the task associated with the GenAI application based on a transition to a home screen associated with the GenAI application or an application switch event. In an embodiment, the method includes updating memory allocation following the termination of the task associated with the GenAI application. In an embodiment, the method includes unloading the one or more GenAI models from the memory in response to a memory pressure condition triggered by one or more non-GenAI applications based on the updating of the memory allocation.

In an embodiment, the method includes detecting that the GenAI application is present in foreground using an application launch or switch listener. In an embodiment, the method includes initiating a multi-generational least recently used (MGLRU) aging technique in response to detecting the GenAI application. In an embodiment, the method includes performing proactive aging of memory pages by comparing a current generation pool with a previous generation pool based on the initiated MGLRU aging technique. In an embodiment, the method includes determining whether to continue aging based on a defined threshold. In an embodiment, the method includes reclaiming memory pages that satisfy an aging condition by triggering the one or more memory reclaimers based on the determined continue aging.

In accordance with an aspect of the disclosure, an electronic device is provided. The electronic device includes memory, comprising one or more storage media, storing instructions. The electronic device includes at least one processor communicatively coupled with the memory. In an embodiment, the instructions, when executed by the at least one processor individually or collectively, cause the electronic device to detect one or more hint signals indicating a task to be performed using the one or more GenAI models. In an embodiment, the instructions, when executed by the at least one processor individually or collectively, cause the electronic device validate the one or more detected hint signals by at least one condition related to a task execution status or authorization of a GenAI application associated with the one or more GenAI models. In an embodiment, the instructions, when executed by the at least one processor individually or collectively, cause the electronic device determine a memory demand and a priority level for the task based on the validated one or more detected hint signals. In an embodiment, the instructions, when executed by the at least one processor individually or collectively, cause the electronic device select one or more memory reclaimers based on the determined memory demand and the priority level. In an embodiment, the instructions, when executed by the at least one processor individually or collectively, cause the electronic device initiate a memory reclamation process using the selected one or more memory reclaimers. In an embodiment, the instructions, when executed by the at least one processor individually or collectively, cause the electronic device to allocate reclaimed memory associated with the memory reclamation process to the task based on receiving a request to execute the task.

In an embodiment, the one or more hint signals comprise at least one of a foreground application launch, a system-level application programming interface (API) call, a framework API call, UI changes, or a user interaction indicating execution the task associated with the GenAI application.

In an embodiment, the instructions, when executed by the at least one processor individually or collectively, cause the electronic device to identify launch of the GenAI application. In an embodiment, the instructions, when executed by the at least one processor individually or collectively, cause the electronic device to detect presence of a specific type of icon rendered on a user device based on the identified launch. In an embodiment, the instructions, when executed by the at least one processor individually or collectively, cause the electronic device to, based on the presence being detected, determine the presence of the specific type of icon as the hint signals and notify the presence of the specific type of icon, to a user before executing the task.

In an embodiment, the instructions, when executed by the at least one processor individually or collectively, cause the electronic device to determine whether the one or more detected hint signals correspond to a valid GenAI application. In an embodiment, the instructions, when executed by the at least one processor individually or collectively, cause the electronic device to verify whether a defined threshold time has elapsed since a previous GenAI memory reclamation operation based on the GenAI application being determined as valid. In an embodiment, the instructions, when executed by the at least one processor individually or collectively, cause the electronic device to determine the one or more detected hint signals as valid only when the defined threshold time has elapsed.

In an embodiment, the instructions, when executed by the at least one processor individually or collectively, cause the electronic device to swap out memory of one or more processes depending on the priority level associated with the task, using the one or more selected memory reclaimers, in one or more threads, until a threshold amount of the memory is achieved for loading the one or more GenAI models. In an embodiment, the instructions, when executed by the at least one processor individually or collectively, cause the electronic device to store a record of the swapped-out memory. In an embodiment, the instructions, when executed by the at least one processor individually or collectively, cause the electronic device to enable, based on the record of the swapped out memory, restoration of the memory to a respective list of low priority applications upon completion of the task. In an embodiment, the instructions, when executed by the at least one processor individually or collectively, cause the electronic device to perform one or more adaptive memory reclamation strategies configured to selectively release the memory based on an application state and the memory demand based on the enabling of the restoration of the memory.

In an embodiment, the instructions, when executed by the at least one processor individually or collectively, cause the electronic device to defragment the memory by performing one or more memory compaction techniques. In an embodiment, the instructions, when executed by the at least one processor individually or collectively, cause the electronic device to generate a continuous block of free memory based on the defragmented memory. In an embodiment, the instructions, when executed by the at least one processor individually or collectively, cause the electronic device to notify the GenAI application that the memory reclamation is complete based one the generation of the continuous block of free memory.

In an embodiment, the instructions, when executed by the at least one processor individually or collectively, cause the electronic device to detect termination of the task associated with the GenAI application based on a transition to a home screen associated with the GenAI application or an application switch event. In an embodiment, the instructions, when executed by the at least one processor individually or collectively, cause the electronic device to update memory allocation following the termination of the task associated with the GenAI application. In an embodiment, the instructions, when executed by the at least one processor individually or collectively, cause the electronic device to upon updating the memory allocation, unload the one or more GenAI models from the memory in response to a memory pressure condition triggered by one or more non-GenAI applications.

In an embodiment, the instructions, when executed by the at least one processor individually or collectively, cause the electronic device to detect that the GenAI application is present in foreground using an application launch or switch listener. In an embodiment, the instructions, when executed by the at least one processor individually or collectively, cause the electronic device to initiate a Multi-Generational Least Recently Used multi-generational least recently used (MGLRU) aging technique in response to detecting the GenAI application. In an embodiment, the instructions, when executed by the at least one processor individually or collectively, cause the electronic device to perform proactive aging of memory pages by comparing a current generation pool with a previous generation pool based on the initiated MGLRU aging technique. In an embodiment, the instructions, when executed by the at least one processor individually or collectively, cause the electronic device to upon performing the proactive aging of memory pages, determine whether to continue aging based on a predefined threshold. In an embodiment, the instructions, when executed by the at least one processor individually or collectively, cause the electronic device to trigger the one or more memory reclaimers to reclaim memory pages that satisfy an aging condition based on the determined continue aging. In an embodiment, the selected one or more memory reclaimers begin freeing memory by compressing, dropping caches, or evicting old or low-priority application pages. In an embodiment, the selected one or more memory reclaimers evict the memory pages from long-idle social media applications and drop thumbnail cache data.

In accordance with an aspect of the disclosure, a computer-readable storage media storing one or more computer programs including computer-executable instructions that, when executed by one or more processors cause the electronic device to perform operations are provided. In an embodiment, the operations include detecting one or more hint signals indicating a task to be performed using the one or more generative artificial intelligence (GenAI) models. In an embodiment, the operations include validating the one or more detected hint signals by at least one condition related to a task execution status, authorization of a GenAI application associated with the one or more GenAI models or threshold time between memory reclamations. In an embodiment, the operations include determining a memory demand and a priority level for the task to be performed based on the validated one or more detected hint signals. In an embodiment, the operations include selecting one or more memory reclaimers based on the determined memory demand and the priority level. In an embodiment, the operations include initiating a memory reclamation process using the selected one or more memory reclaimers. In an embodiment, the operations include allocating reclaimed memory associated with the memory reclamation process to the task based on receiving a request to execute the task.

In an embodiment, the one or more hint signals comprise at least one of: a foreground activity launch, a system-level application programming interface (API) call, a broadcast event, a framework API call, or a user interaction indicating execution the task associated with the GenAI application.

What is claimed is:

1. A method comprising:
detecting one or more hint signals indicating a task to be performed using the one or more generative artificial intelligence (GenAI) models;
validating the one or more detected hint signals by at least one condition related to a task execution status or authorization of a GenAI application associated with the one or more GenAI models;
determining a memory demand and a priority level for the task based on the validated one or more detected hint signals;
selecting one or more memory reclaimers based on the determined memory demand and the priority level;
initiating a memory reclamation process using the selected one or more memory reclaimers; and
allocating reclaimed memory associated with the memory reclamation process to the task based on receiving a request to execute the task.

2. The method of claim 1, wherein the one or more hint signals comprise at least one of: a foreground application launch, a system-level application programming interface (API) call, a framework API call, UI changes, or a user interaction indicating execution the task associated with the GenAI application.

3. The method of claim 1, wherein the detecting of the one or more hint signals comprises:
identifying launch of the GenAI application;
detecting presence of a specific type of icon rendered on a user device based on the identified launch; and
based on the presence being detected, determining the presence of the specific type of icon as the hint signals and notifying the presence of the specific type of icon, to a user before executing the task.

4. The method of claim 1, wherein the validating of the one or more detected hint signals comprises:
determining whether the one or more detected hint signals correspond to a valid GenAI application; and
verifying whether a defined threshold time has elapsed since a previous GenAI memory reclamation operation based on the GenAI application being determined as valid; and
determining the one or more detected hint signals as valid only when the defined threshold time has elapsed.

5. The method of claim 1, wherein the initiating of the memory reclamation process comprises:
swapping out memory of one or more processes depending on the priority level associated with the task, using the one or more selected memory reclaimers, in one or more threads, until a threshold amount of memory is achieved for loading the one or more GenAI models;
storing a record of the swapped out memory;
enabling, based on the record of the swapped out memory, restoration of the memory to a respective list of low priority applications upon completion of the task; and
performing one or more adaptive memory reclamation strategies configured to selectively release the memory based on an application state and the memory demand based on the enabling of the restoration of the memory.

6. The method of claim 1, wherein the initiating of the memory reclamation process comprises:
defragmenting the memory by performing one or more memory compaction techniques;
generating a continuous block of free memory based on the defragmented memory; and
notifying the GenAI application that the memory reclamation is complete based on the generation of the continuous block of free memory.

7. The method of claim 1, further comprising:
detecting termination of the task associated with the GenAI application based on a transition to a home screen associated with the GenAI application or an application switch event;
updating memory allocation following the termination of the task associated with the GenAI application; and
unloading the one or more GenAI models from the memory in response to a memory pressure condition triggered by one or more non-GenAI applications based on the updating of the memory allocation.

8. The method of claim 1, further comprising:
detecting that the GenAI application is present in foreground using an application launch or switch listener;
initiating a multi-generational least recently used (MGLRU) aging technique in response to detecting the GenAI application;
performing proactive aging of memory pages by comparing a current generation pool with a previous generation pool based on the initiated MGLRU aging technique;
determining whether to continue aging based on a defined threshold; and
reclaiming memory pages that satisfy an aging condition by triggering the one or more memory reclaimers based on the determined continue aging.

9. An electronic device comprising:
memory, comprising one or more storage media, storing instructions; and
at least one processor communicatively coupled with the memory,
wherein the instructions, when executed by the at least one processor individually or collectively, cause the electronic device to:
detect one or more hint signals indicating a task to be performed using the one or more generative artificial intelligence (GenAI) models,
validate the one or more detected hint signals by at least one condition related to a task execution status or authorization of a GenAI application associated with the one or more GenAI models,
determine a memory demand and a priority level for the task based on the validated one or more detected hint signals,
select one or more memory reclaimers based on the determined memory demand and the priority level,
initiate a memory reclamation process using the selected one or more memory reclaimers, and
allocate reclaimed memory associated with the memory reclamation process to the task based on receiving a request to execute the task.

10. The electronic device of claim 9, wherein the one or more hint signals comprise at least one of a foreground application launch, a system-level application programming interface (API) call, a framework API call, UI changes, or a user interaction indicating execution the task associated with the GenAI application.

11. The electronic device of claim 9, wherein the instructions, when executed by the at least one processor individually or collectively, further cause the electronic device to:
identify launch of the GenAI application,
detect presence of a specific type of icon rendered on a user device based on the identified launch, and
based on the presence being detected, determine the presence of the specific type of icon as the hint signals and notify the presence of the specific type of icon, to a user before executing the task.

12. The electronic device of claim 9, wherein the instructions, when executed by the at least one processor individually or collectively, cause the electronic device to:
determine whether the one or more detected hint signals correspond to a valid GenAI application,
verify whether a defined threshold time has elapsed since a previous GenAI memory reclamation operation based on the GenAI application being determined as valid, and
determine the one or more detected hint signals as valid only when the defined threshold time has elapsed.

13. The electronic device of claim 9, wherein the instructions, when executed by the at least one processor individually or collectively, cause the electronic device to:
swap out memory of one or more processes depending on the priority level associated with the task, using the one or more selected memory reclaimers, in one or more threads, until a threshold amount of the memory is achieved for loading the one or more GenAI models,
store a record of the swapped-out memory,
enable, based on the record of the swapped out memory, restoration of the memory to a respective list of low priority applications upon completion of the task, and
perform one or more adaptive memory reclamation strategies configured to selectively release the memory based on an application state and the memory demand based on the enabling of the restoration of the memory.

14. The electronic device of claim 9, wherein the instructions, when executed by the at least one processor individually or collectively, cause the electronic device to:
defragment the memory by performing one or more memory compaction techniques,
generate a continuous block of free memory based on the defragmented memory, and
notify the GenAI application that the memory reclamation is complete based one the generation of the continuous block of free memory.

15. The electronic device of claim 9, wherein the instructions, when executed by the at least one processor individually or collectively, cause the electronic device to:
detect termination of the task associated with the GenAI application based on a transition to a home screen associated with the GenAI application or an application switch event;
update memory allocation following the termination of the task associated with the GenAI application; and
unload the one or more GenAI models from the memory in response to a memory pressure condition triggered by one or more non-GenAI applications based on the updating of the memory allocation.

16. The electronic device of claim 9, wherein the instructions, when executed by the at least one processor individually or collectively, further cause the electronic device to:
detect that the GenAI application is present in foreground using an application launch or switch listener;
initiate a multi-generational least recently used (MGLRU) aging technique in response to detecting the GenAI application;
perform proactive aging of memory pages by comparing a current generation pool with a previous generation pool based on the initiated MGLRU aging technique;
determine whether to continue aging based on a defined threshold; and
reclaim memory pages that satisfy an aging condition by triggering the one or more memory reclaimers based on the determined continue aging.

17. The electronic device of claim 9, wherein the selected one or more memory reclaimers begin freeing memory by compressing, dropping caches, or evicting old or low-priority application pages.

18. The electronic device of claim 9, wherein the selected one or more memory reclaimers evict the memory pages from long-idle social media applications and drop thumbnail cache data.

19. One or more non-transitory computer-readable storage media storing one or more computer programs including computer-executable instructions that, when executed by one or more processors of an electronic device individually or collectively, cause the electronic device to perform operations, the operations comprising:
detecting one or more hint signals indicating a task to be performed using the one or more generative artificial intelligence (GenAI) models;
validating the one or more detected hint signals by at least one condition related to a task execution status or authorization of a GenAI application associated with the one or more GenAI models;
determining a memory demand and a priority level for the task to be performed based on the validated one or more detected hint signals;
selecting one or more memory reclaimers based on the determined memory demand and the priority level;
initiating a memory reclamation process using the selected one or more memory reclaimers; and
allocating reclaimed memory associated with the memory reclamation process to the task based on receiving a request to execute the task.

20. The one or more non-transitory computer-readable storage media of claim 19, wherein the one or more hints comprise at least one of: a foreground application launch, a system-level application programming interface (API) call, a framework API call, UI changes, or a user interaction indicating execution the task associated with the GenAI application.
